(19) United States
(12) Patent Application Publication
(10) Pub. No.: US 2018/0121321 A1
(43) Pub. Date: May 3, 2018

(54) System And Method For Monitoring Services And Blocks Within A Configurable Platform Instance

(71) Applicant: n.io Innovation, LLC, Broomfield, CO (US)

(72) Inventors: Douglas A. STANDLEY, Boulder, CO (US); Randall E. BYE, Louisville, CO (US); Matthew R. DODGE, Dana Point, CA (US)

(21) Appl. No.: 15/794,835

(22) Filed: Oct. 26, 2017

Related U.S. Application Data
(60) Provisional application No. 62/416,540, filed on Nov. 2, 2016.

(51) Int. Cl. G06F 11/36; G06F 11/07

(52) U.S. Cl. CPC G06F 11/3612; H04L 67/10; G06F 11/0766; G06F 11/0751

(57) ABSTRACT

An improved system and method are disclosed for monitoring a plurality of mini runtime environments provided by a software platform. In one example, the software platform includes a core, multiple services, a monitoring component, and multiple blocks. The core is configured to interact with an operating system running on a device on which the core is running and includes the monitoring component. The services are configured to be run by the core. Each service provides a mini runtime environment for the blocks assigned to that service. The monitoring component monitors a current status of each service. Each of the blocks is configurable to run asynchronously and independently from the other blocks. The software platform is configurable to individually monitor any of the blocks for errors while the blocks are running within the mini runtime environment of the service to which the block is assigned.

### RELATED APPLICATIONS

This application claims the benefit, under 35 USC 119(e), of the filing of U.S. Provisional Patent Application No. 62/416,540, entitled “System and Method for Monitoring and Restarting Services Within a Configurable Platform Instance,” filed Nov. 2, 2016, which is incorporated herein by reference for all purposes.

### BACKGROUND

The proliferation of devices has resulted in the production of a tremendous amount of data that is continuously increasing. Current processing methods are unsuitable for processing this data. Accordingly, what is needed are systems and methods that address this issue.

### BRIEF DESCRIPTION OF THE DRAWINGS

For a more complete understanding, reference is now made to the following description taken in conjunction with the accompanying Drawings in which:

FIG. 1A illustrates one embodiment of a neutral input/output (NIO) platform with customizable and configurable processing functionality and configurable support functionality;

FIG. 1B illustrates one embodiment of a data path that may exist within a NIO platform instance based on the NIO platform of FIG. 1A;

FIGS. 1C and 1D illustrate embodiments of the NIO platform of FIG. 1A as part of a stack;

FIG. 1E illustrates one embodiment of a system on which the NIO platform of FIG. 1A may be run;

FIG. 2 illustrates a more detailed embodiment of the NIO platform of FIG. 1A;

FIG. 3A illustrates another embodiment of the NIO platform of FIG. 2;

FIG. 3B illustrates one embodiment of a NIO platform instance based on the NIO platform of FIG. 3A;

FIG. 4A illustrates one embodiment of a workflow that may be used to create and configure a NIO platform;

FIG. 4B illustrates one embodiment of a user's perspective of a NIO platform;

FIG. 5A illustrates one embodiment of a different perspective of the NIO platform instance of FIG. 3B;

FIG. 5B illustrates one embodiment of a hierarchical flow that begins with task specific functionality and ends with NIO platform instances;

FIG. 6 illustrates one embodiment of the NIO platform of FIG. 4A with monitoring functionality;

FIG. 7 illustrates one embodiment of a method that may be executed by the NIO platform of FIG. 4A or FIG. 6 to monitor a service running on the NIO platform and take action if the service is not running correctly;

FIG. 8 illustrates one embodiment of a process that may be used to monitor a service by the method of FIG. 7;

FIG. 9 illustrates another embodiment of a process that may be used to monitor a service by the method of FIG. 7;

FIG. 10A illustrates another embodiment of a process that may be used to monitor a service by the method of FIG. 7;

FIG. 10B illustrates one embodiment of a process that may be used to report the status of a service by the method of FIG. 10A;

FIG. 11A illustrates a sequence diagram for an embodiment of a process that may be used to monitor a service;

FIG. 11B illustrates further a sequence diagram for an embodiment of a process that may be used to monitor a service;

FIG. 12A illustrates one embodiment of a process that may be used to monitor a service;

FIG. 12B illustrates another embodiment of a process that may be used to monitor a service;

FIG. 13 illustrates another embodiment of a process that may be used to monitor a service;

FIG. 14 illustrates another embodiment of a process that may be used to monitor a service;

FIG. 15 illustrates another embodiment of a process that may be used to monitor a service;

FIG. 16 illustrates another embodiment of a process that may be used to monitor a service;

FIG. 17 illustrates another embodiment of a process that may be used to monitor a service;

FIG. 18 illustrates one embodiment of a process that may be executed by the NIO platform of FIG. 4A or FIG. 6 to monitor and restart a service;

FIG. 19 illustrates another embodiment of a process that may be executed by the NIO platform of FIG. 4A or FIG. 6 to monitor and restart a service;

FIG. 20A illustrates one embodiment of a sequence diagram that shows communications between a service and a block that many occur to monitor the block and take action if the block is not running correctly;

FIG. 20B illustrates another embodiment of a sequence diagram that shows communications between a service and a block that many occur to monitor the block and take action if the block is not running correctly;

FIG. 21 illustrates one embodiments of a method that may be executed by the NIO platform of FIG. 4A or FIG. 6 to monitor a block running within a service on the NIO platform and take action if the block is not running correctly; and

FIG. 22 illustrates another embodiment of a method that may be executed by the NIO platform of FIG. 4A or FIG. 6 to monitor a block running within a service on the NIO platform and take action if the block is not running correctly.

### DETAILED DESCRIPTION

The present disclosure is directed to a system and method for monitoring services and blocks within a neutral input/output platform instance. It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

This application refers to U.S. patent application Ser. No. 14/885,629, filed on Oct. 16, 2015, and entitled SYSTEM AND METHOD FOR FULLY CONFIGURABLE REAL TIME PROCESSING, which is a continuation of PCT/IB2015/001288, filed on May 21, 2015, both of which are incorporated by reference in their entirety.

The present disclosure describes various embodiments of a neutral input/output (NIO) platform that includes a core that supports one or more services. While the platform itself may technically be viewed as an executable application in some embodiments, the core may be thought of as an application engine that runs task specific applications called services. The services are constructed using defined templates that are recognized by the core, although the templates can be customized to a certain extent. The core is designed to manage and support the services, and the services in turn manage blocks that provide processing functionality to their respective service. Due to the structure and flexibility of the runtime environment provided by the NIO platform's core, services, and blocks, the platform is able to asynchronously process any input signal from one or more sources in real time.

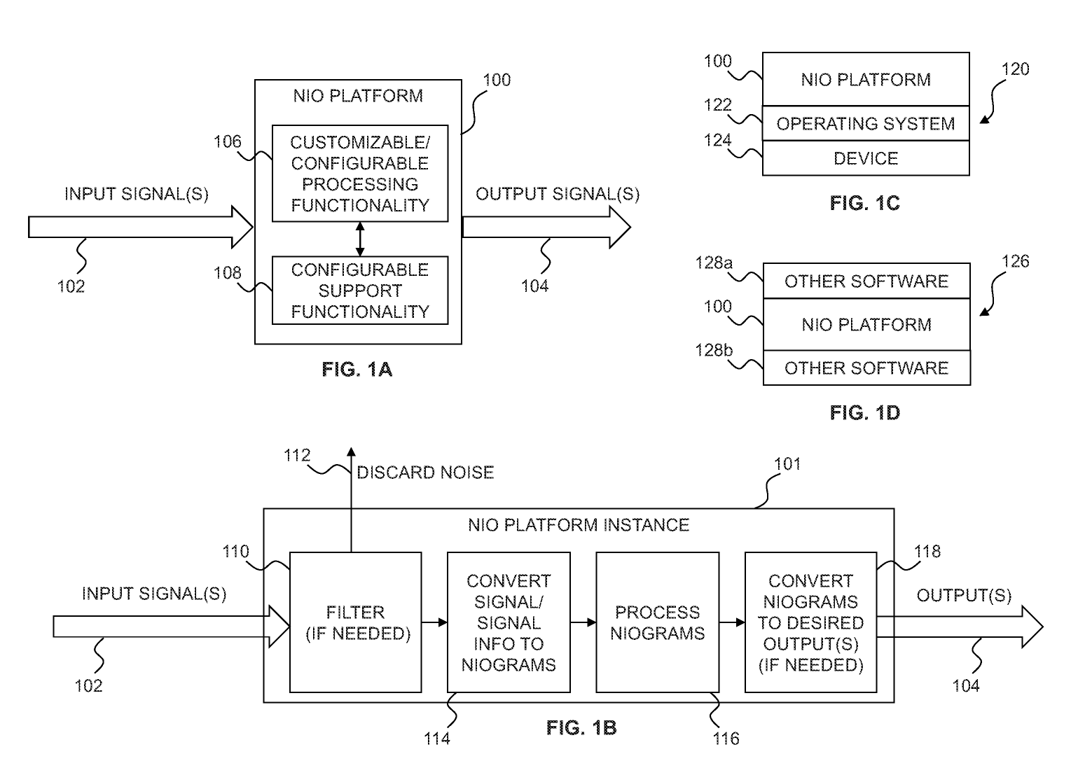

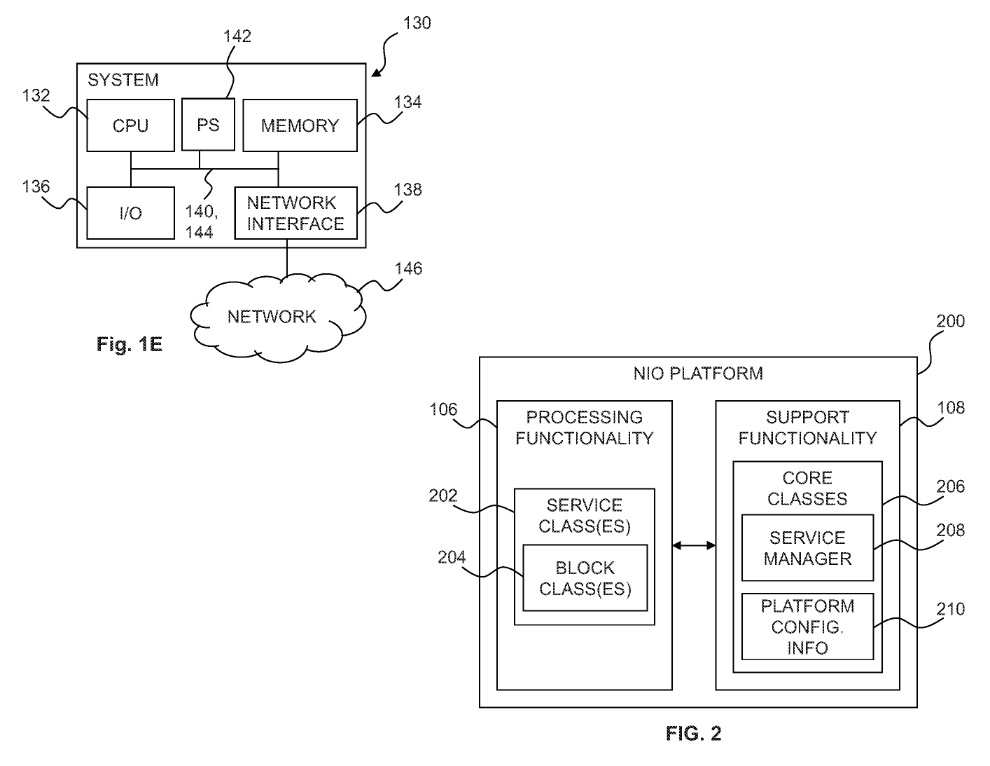

Referring to FIG. 1A, one embodiment of a NIO platform 100 is illustrated. The NIO platform 100 is configurable to receive any type of signal (including data) as input, process those signals, and produce any type of output. The NIO platform 100 is able to support this process of receiving, processing, and producing in real time or near real time. The input signals can be streaming or any other type of continuous or non-continuous input.

When referring to the NIO platform 100 as performing processing in real time and near real time, it means that there is no storage other than possible queuing between the NIO platform instance's input and output. In other words, only processing time exists between the NIO platform instance's input and output as there is no storage read and write time, even for streaming data entering the NIO platform 100.

It is noted that this means there is no way to recover an original signal that has entered the NIO platform 100 and been processed unless the original signal is part of the output or the NIO platform 100 has been configured to save the original signal. The original signal is received by the NIO platform 100, processed (which may involve changing and/or destroying the original signal), and output is generated. The receipt, processing, and generation of output occurs without any storage other than possible queuing. The original signal is not stored and deleted, it is simply never stored. The original signal generally becomes irrelevant as it is the output based on the original signal that is important, although the output may contain some or all of the original signal. The original signal may be available elsewhere (e.g., at the original signal's source), but it may not be recoverable from the NIO platform 100.

It is understood that the NIO platform 100 can be configured to store the original signal at receipt or during processing, but that is separate from the NIO platform's ability to perform real time and near real time processing. For example, although no long term (e.g., longer than any necessary buffering) memory storage is needed by the NIO platform 100 during real time and near real time processing, storage to and retrieval from memory (e.g., a hard drive, a removable memory, and/or a remote memory) is supported if required for particular applications.

The internal operation of the NIO platform 100 uses a NIO data object (referred to herein as a niogram). Incoming signals 102 are converted into niograms at the edge of the NIO platform 100 and used in intra-platform communications and processing. This allows the NIO platform 100 to handle any type of input signal without needing changes to the platform's core functionality. In embodiments where multiple NIO platforms are deployed, niograms may be used in inter-platform communications.

The use of niograms allows the core functionality of the NIO platform 100 to operate in a standardized manner regardless of the specific type of information contained in the niograms. From a general system perspective, the same core operations are executed in the same way regardless of the input data type. This means that the NIO platform 100 can be optimized for the niogram, which may itself be optimized for a particular type of input for a specific application.

The NIO platform 100 is designed to process niograms in a customizable and configurable manner using processing functionality 106 and support functionality 108. The processing functionality 106 is generally both customizable and configurable by a user. Customizable means that at least a portion of the source code providing the processing functionality 106 can be modified by a user. In other words, the task specific software instructions that determine how an input signal that has been converted into one or more niograms will be processed can be directly accessed at the code level and modified. Configurable means that the processing functionality 106 can be modified by such actions as selecting or deselecting functionality and/or defining values for configuration parameters. These modifications do not require direct access or changes to the underlying source code and may be performed at different times (e.g., before runtime or at runtime) using configuration files, commands issued through an interface, and/or in other defined ways.

The support functionality 108 is generally only configurable by a user, with modifications limited to such actions as selecting or deselecting functionality and/or defining values for configuration parameters. In other embodiments, the support functionality 108 may also be customizable. It is understood that the ability to modify the processing functionality 106 and/or the support functionality 108 may be limited or non-existent in some embodiments.

The support functionality 108 supports the processing functionality 106 by handling general configuration of the NIO platform 100 at runtime and providing management functions for starting and stopping the processing functionality. The resulting niograms can be converted into any signal type(s) for output(s) 104.

Referring to FIG. 1B, one embodiment of a NIO platform instance 101 illustrates a data path that starts when the input signal(s) 102 are received and continues through the generation of the output(s) 104. The NIO platform instance 101 is created when the NIO platform 100 of FIG. 1A is launched. A NIO platform may be referred to herein as a “NIO platform” before being launched and as a “NIO platform instance” after being launched, although the terms may be used interchangeably for the NIO platform after launch. As described above, niograms are used internally by the NIO platform instance 101 along the data path.

In the present example, the input signal(s) 102 may be filtered in block 110 to remove noise, which can include irrelevant data, undesirable characteristics in a signal (e.g., ambient noise or interference), and/or any other unwanted part of an input signal. Filtered noise may be discarded at the edge of the NIO platform instance 101 (as indicated by arrow 112) and not introduced into the more complex processing functionality of the NIO platform instance 101. The filtering may also be used to discard some of the signal's information while keeping other information from the signal. The filtering saves processing time because core functionality of the NIO platform instance 101 can be focused on relevant data having a known structure for post-filtering processing. In embodiments where the entire input signal is processed, such filtering may not occur. In addition to or as alternative to filtering occurring at the edge, filtering may occur inside the NIO platform instance 101 after the signal is converted to a niogram.

Non-discarded signals and/or the remaining signal information are converted into niograms for internal use in block 114 and the niograms are processed in block 116. The niograms may be converted into one or more other formats for the output(s) 104 in block 118, including actions (e.g., actuation signals). In embodiments where niograms are the output, the conversion step of block 118 would not occur.

Referring to FIG. 1C, one embodiment of a stack 120 is illustrated. In the present example, the NIO platform 100 interacts with an operating system (OS) 122 that in turn interacts with a device 124. The interaction may be direct or may be through one or more other layers, such as an interpreter or a virtual machine. The device 124 can be a virtual device or a physical device, and may be standalone or coupled to a network.

Referring to FIG. 1D, another embodiment of a stack 126 is illustrated. In the present example, the NIO platform 100 interacts with a higher layer of software 128a and/or a lower layer of software 128b. In other words, the NIO platform 100 may provide part of the functionality of the stack 126, while the software layers 128a and/or 128b provide other parts of the stack's functionality. Although not shown, it is understood that the OS 122 and device 124 of FIG. 1C may be positioned under the software layer 128b if the software 128b is present or directly under the NIO platform 100 (as in FIG. 1C) if the software layer 128b is not present.

Referring to FIG. 1E, one embodiment of a system 130 is illustrated. The system 130 is one possible example of a portion or all of the device 124 of FIG. 1C. The system 130 may include a controller (e.g., a processor/central processing unit (“CPU”)) 132, a memory unit 134, an input/output (“I/O”) device 136, and a network interface 138. The components 132, 134, 136, and 138 are interconnected by a data transport system (e.g., a bus) 140. A power supply (PS) 142 may provide power to components of the system 130 via a power transport system 144 (shown with data transport system 140, although the power and data transport systems may be separate).

It is understood that the system 130 may be differently configured and that each of the listed components may actually represent several different components. For example, the CPU 132 may actually represent a multi-processor or a distributed processing system; the memory unit 134 may include different levels of cache memory, main memory, hard disks, and remote storage locations; the I/O device 136 may include monitors, keyboards, and the like; and the network interface 138 may include one or more network cards providing one or more wired and/or wireless connections to a network 146. Therefore, a wide range of flexibility is anticipated in the configuration of the system 130, which may range from a single physical platform configured primarily for a single user or autonomous operation to a distributed multi-user platform such as a cloud computing system.

The system 130 may use any operating system (or multiple operating systems), including various versions of operating systems provided by Microsoft (such as WINDOWS), Apple (such as Mac OS X), UNIX, and LINUX, and may include operating systems specifically developed for handheld devices (e.g., iOS, Android, Blackberry, and/or Windows Phone), personal computers, servers, and other computing platforms depending on the use of the system 130. The operating system, as well as other instructions (e.g., for telecommunications and/or other functions provided by the device 124), may be stored in the memory unit 134 and executed by the processor 132. For example, if the system 130 is the device 124, the memory unit 134 may include instructions for providing the NIO platform 100 and for performing some or all of the methods described herein.

The network 146 may be a single network or may represent multiple networks, including networks of different types, whether wireless or wireline. For example, the device 124 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 124 with external devices.

Referring to FIG. 2, a NIO platform 200 illustrates a more detailed embodiment of the NIO platform 100 of FIG. 1A. In the present example, the NIO platform 200 includes two main components: service classes 202 for one or more services that are to provide the configurable processing functionality 106 and core classes 206 for a core that is to provide the support functionality 108 for the services. Each service corresponds to block classes 204 for one or more blocks that contain defined task specific functionality for processing niograms. The core includes a service manager 208 that will manage the services (e.g., starting and stopping a service) and platform configuration information 210 that defines how the NIO platform 200 is to be configured, such as what services are available when the instance is launched.

When the NIO platform 200 is launched, a core and the corresponding services form a single instance of the NIO platform 200. It is understood that multiple concurrent instances of the NIO platform 200 can run on a single device (e.g., the device 124 of FIG. 1C). Each NIO platform instance has its own core and services. The most basic NIO platform instance is a core with no services. The functionality provided by the core would exist, but there would be no services on which the functionality could operate. Because the processing functionality of a NIO platform instance is defined by the executable code present in the blocks and the services are configured as collections of one or more blocks, a single service containing a single block is the minimum configuration required for any processing of a niogram to occur.

It is understood that FIG. 2 illustrates the relationship between the various classes and other components. For example, the block classes are not actually part of the service classes, but the blocks are related to the services. Furthermore, while the service manager is considered to be part of the core for purposes of this example (and so created using the core classes), the core configuration information is not part of the core classes but is used to configure the core and other parts of the NIO platform 200.

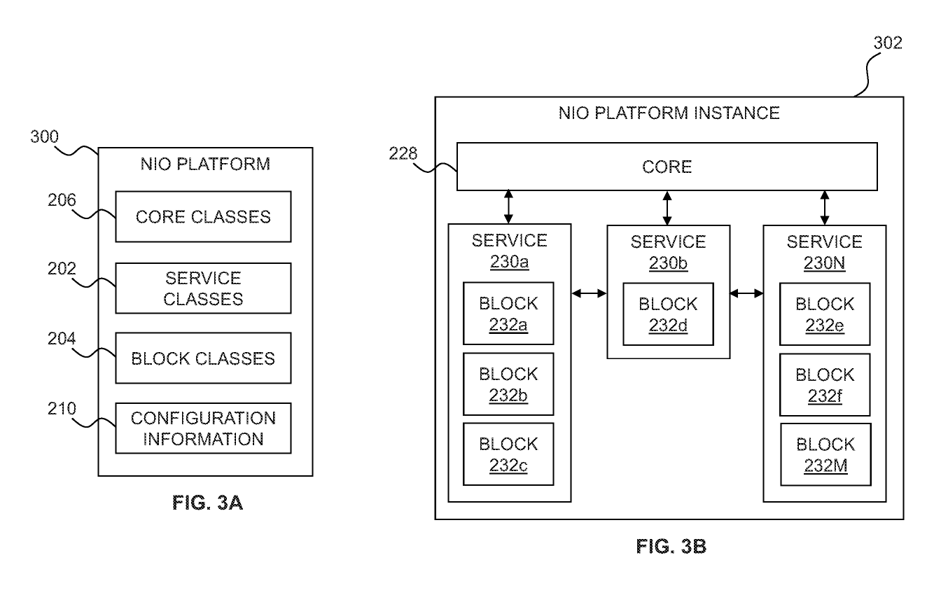

With additional reference to FIGS. 3A and 3B, another embodiment of the NIO platform 200 of FIG. 2 is illustrated as a NIO platform 300 prior to being launched (FIG. 3A) and as a NIO platform instance 302 after being launched (FIG. 3B). FIG. 3A illustrates the NIO platform 300 with core classes 206, service classes 202, block classes 204, and configuration information 210 that are used to create and configure a core 228, services 230a-230N, and blocks 232a-232M of the NIO platform instance 302. It is understood that, although not shown in FIG. 3B, the core classes 206, service classes 202, block classes 204, and configuration information 210 generally continue to exist as part of the NIO platform instance 402.

Referring specifically to FIG. 3B, the NIO platform instance 302 may be viewed as a runtime environment within which the core 228 creates and runs the services 230a, 230b, . . . , and 230N. Each service 230a-230N may have a different number of blocks. For example, service 230a includes blocks 232a, 232b, and 232c. Service 230b includes a single block 232d. Service 230N includes blocks 232e, 232f, . . . , and 232M.

One or more of the services 230a-230N may be stopped or started by the core 228. When stopped, the functionality provided by that service will not be available until the service is started by the core 228. Communication may occur between the core 228 and the services 230a-230N, as well as between the services 230a-230N themselves.

In the present example, the core 228 and each service 230a-230N is a separate process from an operating system/hardware perspective. Accordingly, the NIO platform instance 302 of FIG. 3B would have N+1 processes running, and the operating system may distribute those across multi-core devices as with any other processes. It is understood that the configuration of particular services may depend in part on a design decision that takes into account the number of processes that will be created. For example, it may be desirable from a process standpoint to have numerous but smaller services in some embodiments, while it may be desirable to have fewer but larger services in other embodiments. The configurability of the NIO platform 300 enables such decisions to be implemented relatively easily by modifying the functionality of each service 230a-230N.

In other embodiments, the NIO platform instance 302 may be structured to run the core 228 and/or services 230a-230N as threads rather than processes. For example, the core 228 may be a process and the services 230a-230N may run as threads of the core process.

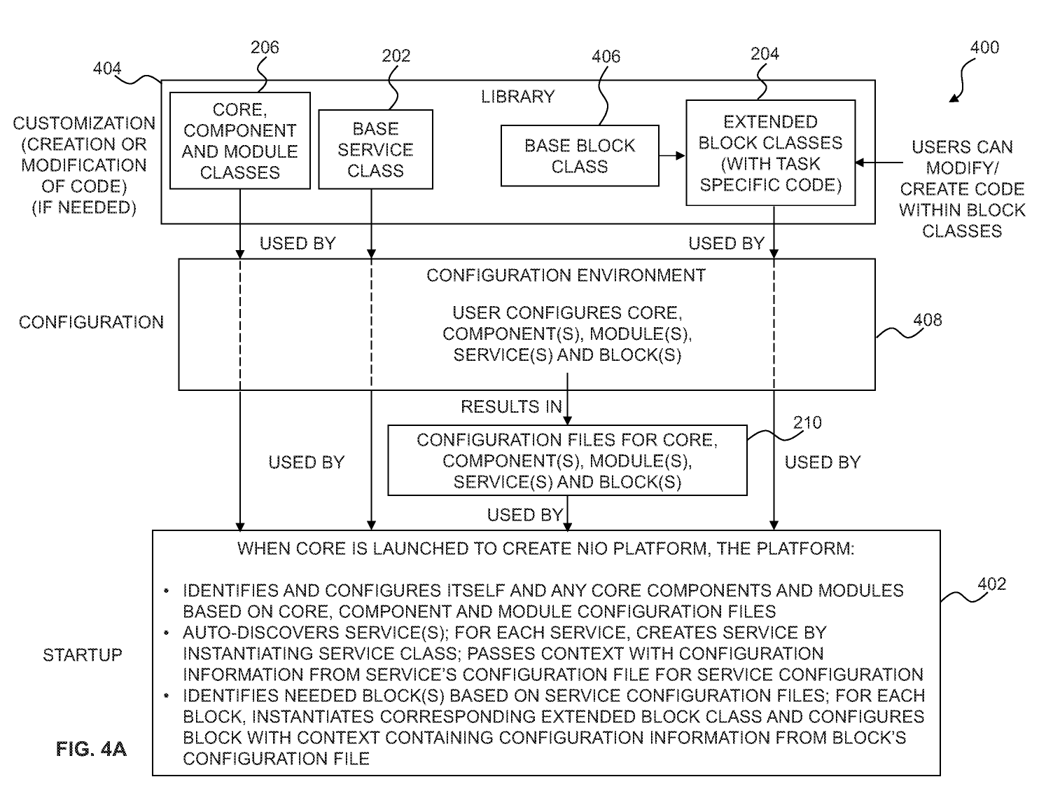

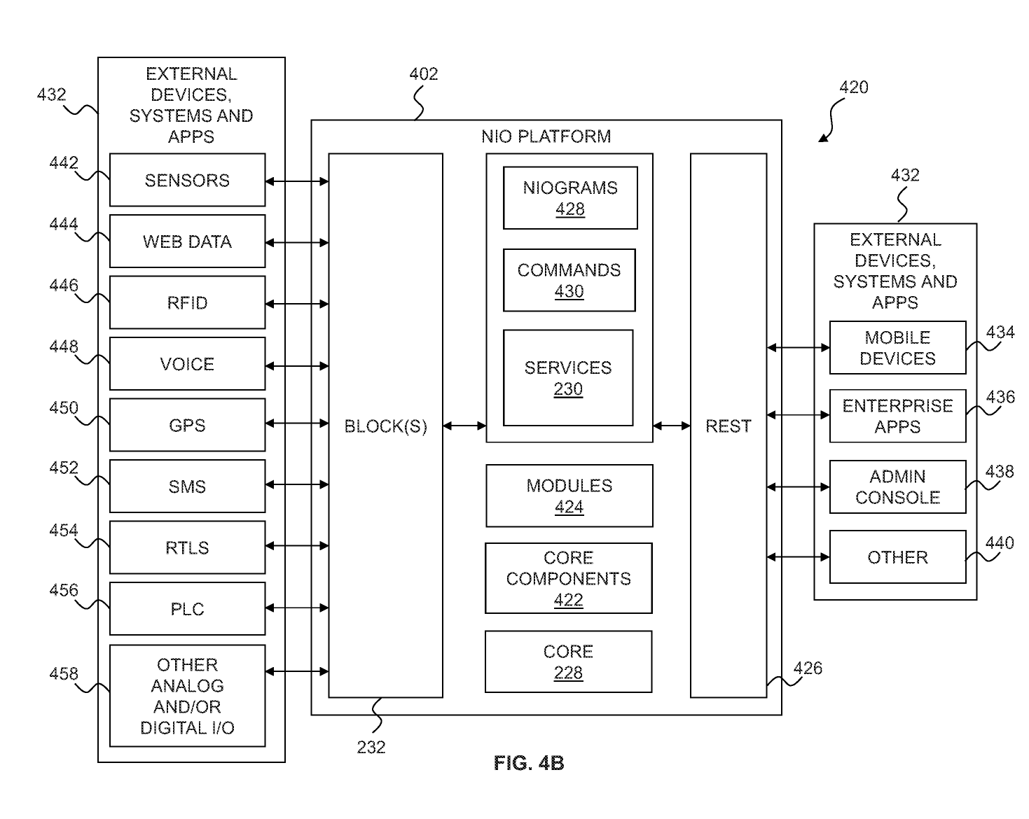

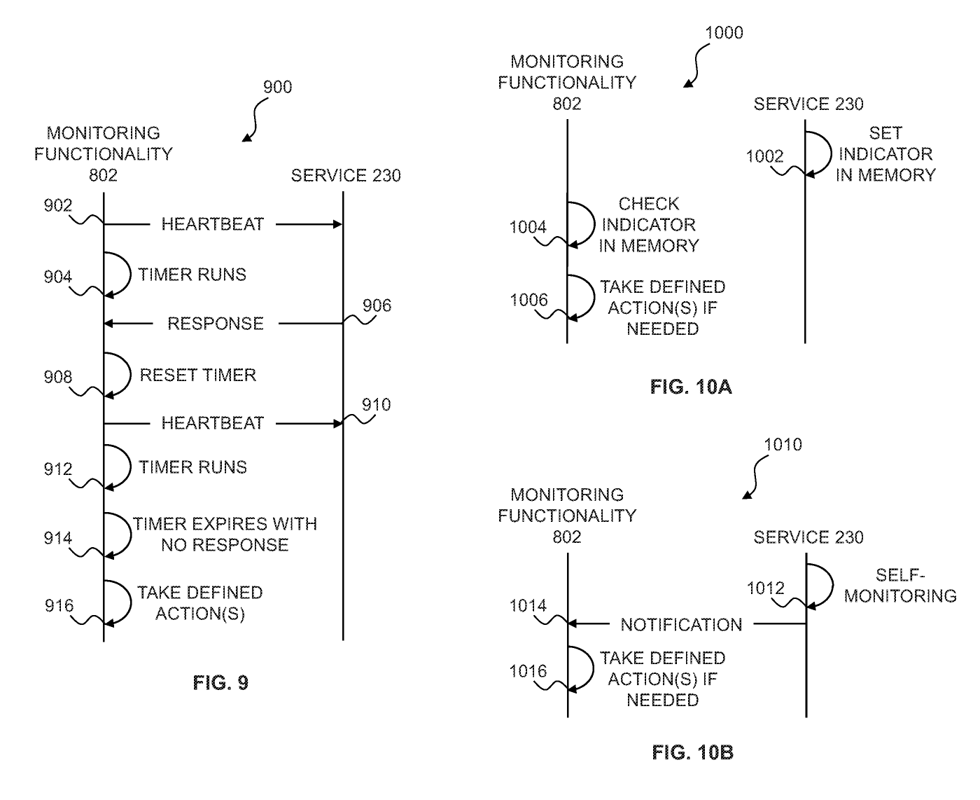

Referring to FIG. 4A, a diagram 400 illustrates one embodiment of a workflow that runs from creation to launch of a NIO platform 402 (which may be similar or identical to the NIO platform 100 of FIG. 1A, 200 of FIG. 2, and/or 300/302 of FIGS. 3A and 3B, as well as 900 of FIGS. 9A and 9B of previously referenced U.S. patent application Ser. No. 14/885,629). The workflow begins with a library 404. The library 404 includes core classes 206 (that include the classes for any core components and modules in the present example), a base service class 202, a base block class 406, and block classes 204 that are extended from the base block class 406. Each extended block class 204 includes task specific code. A user can modify and/or create code for existing blocks classes 204 in the library 404 and/or create new block classes 204 with desired task specific functionality. Although not shown, the base service class 202 can also be customized and various extended service classes may exist in the library 404.

The configuration environment 408 enables a user to define configurations for the core classes 206, the service class 202, and the block classes 204 that have been selected from the library 404 in order to define the platform specific behavior of the objects that will be instantiated from the classes within the NIO platform 402. The NIO platform 402 will run the objects as defined by the architecture of the platform itself, but the configuration process enables the user to define various task specific operational aspects of the NIO platform 402. The operational aspects include which core components, modules, services and blocks will be run, what properties the core components, modules, services and blocks will have (as permitted by the architecture), and when the services will be run. This configuration process results in configuration files 210 that are used to configure the objects that will be instantiated from the core classes 206, the service class 202, and the block classes 204 by the NIO platform 402.

In some embodiments, the configuration environment 408 may be a graphical user interface environment that produces configuration files that are loaded into the NIO platform 402. In other embodiments, the configuration environment 408 may use a REST interface (such as the REST interface 908, 964 disclosed in FIGS. 9A and 9B of previously referenced U.S. patent application Ser. No. 14/885,629) of the NIO platform 402 to issue configuration commands to the NIO platform 402. Accordingly, it is understood that there are various ways in which configuration information may be created and produced for use by the NIO platform 402.

When the NIO platform 402 is launched, each of the core classes 206 are identified and corresponding objects are instantiated and configured using the appropriate configuration files 210 for the core, core components, and modules. For each service that is to be run when the NIO platform 402 is started, the service class 202 and corresponding block classes 204 are identified and the services and blocks are instantiated and configured using the appropriate configuration files 210. The NIO platform 402 is then configured and begins running to perform the task specific functions provided by the services.

Referring to FIG. 4B, one embodiment of an environment 420 illustrates a user's perspective of the NIO platform 402 of FIG. 4A with external devices, systems, and applications 432. From the user's perspective, much of the functionality of the core 228, which may include core components 422 and/or modules 424, is hidden. Various core components 422 and modules 424 are discussed in greater detail in previously referenced U.S. patent application Ser. No. 14/885,629 and are not described further in the present example. The user has access to some components of the NIO platform 402 from external devices, systems, and applications 432 via a REST API 426. The external devices, systems, and applications 432 may include mobile devices 434, enterprise applications 436, an administration console 438 for the NIO platform 402, and/or any other external devices, systems, and applications 440 that may access the NIO platform 402 via the REST API.

Using the external devices, systems, and applications 432, the user can issue commands 430 (e.g., start and stop commands) to services 230, which in turn either process or stop processing niograms 428. As described above, the services 230 use blocks 232, which may receive information from and send information to various external devices, systems, and applications 432. The external devices, systems, and applications 432 may serve as signal sources that produce signals using sensors 442 (e.g., motion sensors, vibration sensors, thermal sensors, electromagnetic sensors, and/or any other type of sensor), the web 444, RFID 446, voice 448, GPS 450, SMS 452, RTLS 454, PLC 456, and/or any other analog and/or digital signal source 458 as input for the blocks 232. The external devices, systems, and applications 432 may serve as signal destinations for any type of signal produced by the blocks 232, including actuation signals. It is understood that the term “signals” as used herein includes data.

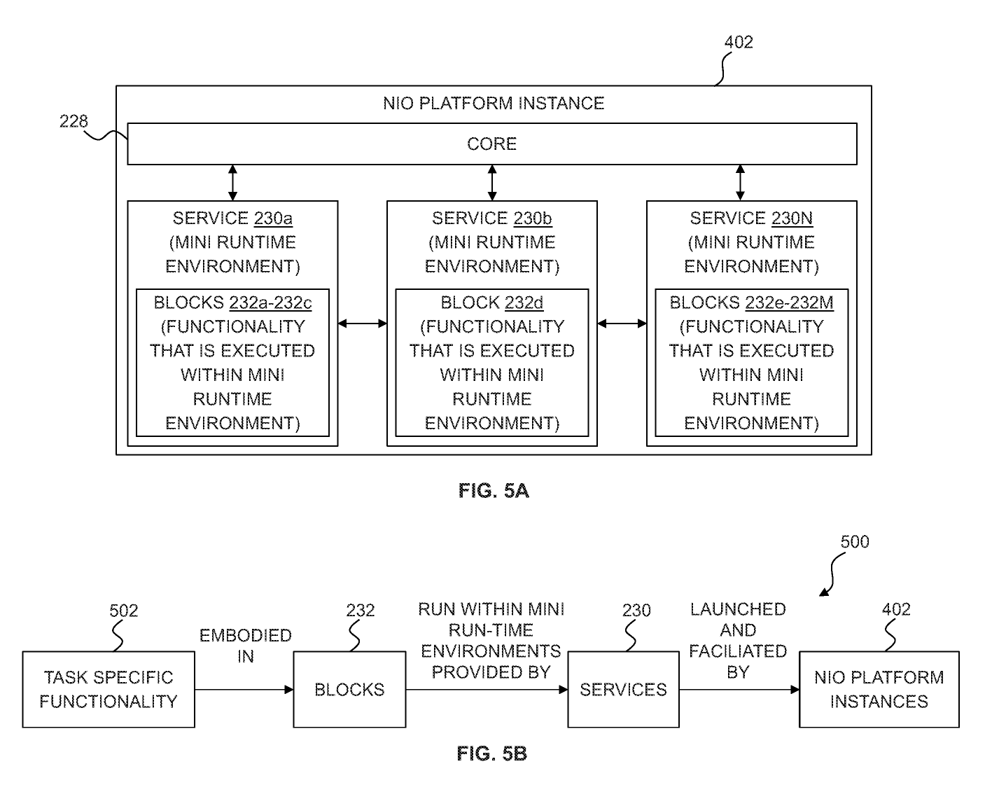

Referring to FIG. 5A, one embodiment of the NIO platform instance 402 illustrates a different perspective of the NIO platform instance 302 of FIG. 3B. The NIO platform instance 402 (which may be similar or identical to the NIO platform 100 of FIG. 1A, 200 of FIG. 2A, 300 of FIG. 3A, 302 of FIG. 3B, and/or 402 of FIGS. 4A and 4B) is illustrated from the perspective of the task specific functionality that is embodied in the blocks. As described in previously referenced U.S. patent application Ser. No. 14/885,629, services 230 provide a framework within which blocks 232 are run, and a block cannot run outside of a service. This means that a service 230 can be viewed as a wrapper around a particular set of blocks 232 that provides a mini runtime environment for those blocks.

From this perspective, a service 230 is a configured wrapper that provides a mini runtime environment for the blocks 232 associated with the service. The base service class 202 (FIG. 4A) is a generic wrapper that can be configured to provide the mini runtime environment for a particular set of blocks 232. The base block class 406 (FIG. 4A) provides a generic component designed to operate within the mini runtime environment provided by a service 230. A block 232 is a component that is designed to run within the mini runtime environment provided by a service 230, and generally has been extended from the base block class 406 to contain task specific functionality that is available when the block 232 is running within the mini runtime environment. The purpose of the core 228 is to launch and facilitate the mini runtime environments.

To be clear, these are the same services 230, blocks 232, base service class 202, base block class 406, and core 228 that have been described previously. However, this perspective focuses on the task specific functionality that is to be delivered, and views the NIO platform 402 as the architecture that defines how that task specific functionality is organized, managed, and run. Accordingly, the NIO platform 402 provides the ability to take task specific functionality and run that task specific functionality in one or more mini runtime environments.

Referring to FIG. 5B, a diagram 500 illustrates one embodiment of a hierarchical flow that begins with task specific functionality 502 and ends with NIO platform instances 402. More specifically, the task specific functionality 502 is encapsulated within blocks 232, and those blocks may be divided into groups (not shown). Each group of blocks is wrapped in a service 230. Each service 230 is configured to run its blocks 232 within the framework (e.g., the mini runtime environment) provided by the service 230. The configuration of a service 230 may be used to control some aspects of that particular service's mini runtime environment. This means that even though the basic mini runtime environment is the same across all the services 230, various differences may still exist (e.g., the identification of the particular blocks 232 to be run by the service 230, the order of execution of those blocks 232, and/or whether the blocks 232 are to be executed synchronously or asynchronously).

Accordingly, the basic mini runtime environment provided by the base service class 202 ensures that any block 232 that is based on the base block class 406 will operate within a service 230 in a known manner, and the configuration information for the particular service enables the service to run a particular set of blocks. The services 230 can be started and stopped by the core 228 of the NIO platform 402 that is configured to run that service.

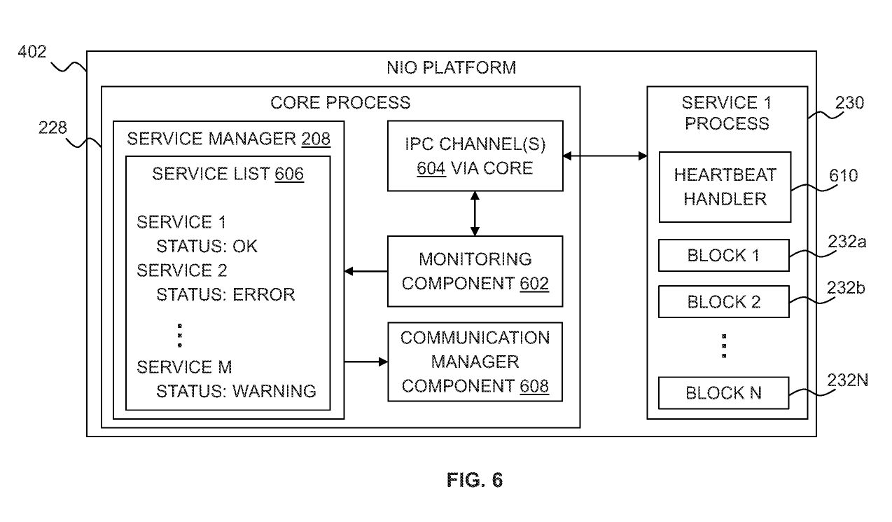

Referring to FIG. 6, one embodiment of the NIO platform 402 is illustrated with monitoring functionality. There are generally two levels of monitoring that may be performed with respect to a service 230 in the NIO platform 402. The first level is directed to monitoring the service process itself and may include monitoring various service level components, such as a block router. The second level is directed to monitoring the individual blocks within the service. From an error notification standpoint, the two levels may be combined so that a block error is reflected as a service error in the service running that block. However, it may be beneficial if block errors are reported and/or handled separately, at least for some blocks. Although different monitoring implementations may be used, the core 228 generally monitors a service and a service monitors its blocks or the blocks self-monitor and report to the service.

The monitoring functionality may be provided by one or more parts of the NIO platform instance 402, such as the service manager 208 (FIG. 2), a monitoring component 602, and/or another service 230. In the present example, the monitoring functionality is provided by the monitoring component 602, which is one of the core components 422 (FIG. 4B).

For purposes of illustration, the monitoring component 602 communicates with the service 230 (Service 1) via one or more interprocess communication (IPC) channels 604 established between the core process 228 and the service process 230. It is understood that the IPC channel(s) 604 are not actually part of the core 228, but are shown in FIG. 6 to illustrate that the monitoring component 602 is using the IPC channels 604 established between the core process 228 and the service process 230 to communicate with the service. Although not shown, the monitoring component 602 may also be communicating with Services 2-M.

The monitoring component 602 may communicate status changes to the service manager 208, which maintains a list 606 of all services and their current status. For purposes of illustration, Service 1 has a status “OK” indicating it is running normally, Service 2 has a status “ERROR” indicating it is in an error state, and Service M has a status “WARNING” indicating it is in a warning state (e.g., not in an error state but not running correctly). Each service 1-M has one or more blocks, such as blocks 1-N shown for Service 1. The list 606 may be used by a communication manager 608 (e.g., one of the core components 422 or modules 424) to notify other services when a particular service's status changes.

The service 230 includes a heartbeat handler 610 that interacts with the monitoring component 602 using heartbeats that indicate that the service 230 is alive. In some embodiments, the heartbeats may include the service's status, while in other embodiments the service's status may be communicated separately from the heartbeat.

It is understood that the embodiment of FIG. 6 is one example and that many variations are possible. For example, the service 230 and core 228 may communicate in many ways other than, or in addition to, the illustrated IPC channel(s) 604, such as using a publication/subscription model and/or an http model. In another example, the functionality of the monitoring component 602 and the service manager 208 may be combined or further separated. In yet another example, the service's status may be monitored and/or communicated in ways other than, or in addition to, a heartbeat mechanism.

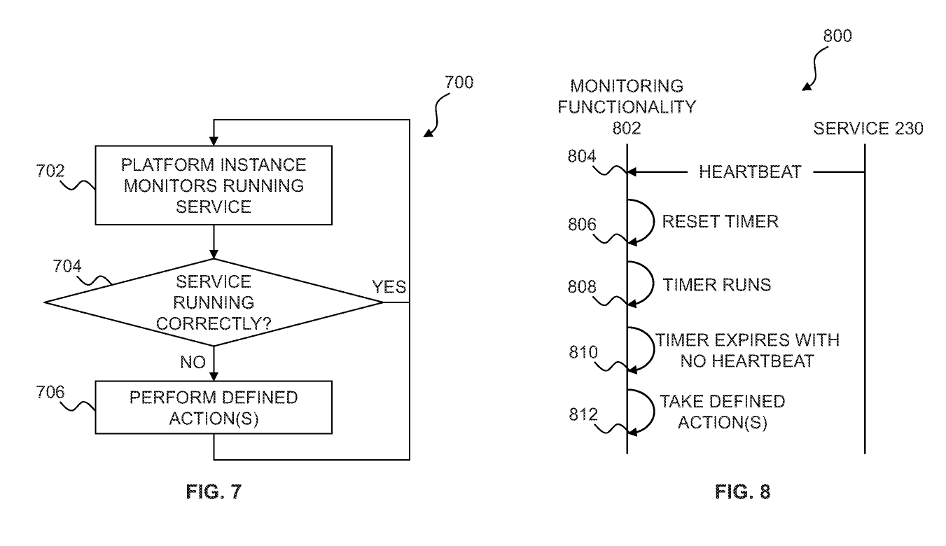

Referring to FIG. 7, a method 700 illustrates one embodiment of a process that may be executed by a NIO platform, such as the NIO platform 402 of FIG. 4A or FIG. 6. The method 700 may be used to monitor one or more services 230 and perform one or more defined actions if one of the services becomes non-responsive or otherwise malfunctions.

There are different possible scenarios that can result in a malfunctioning service 230, with the severity of a particular malfunction determining whether the service 230 continues running or not. For example, in an embodiment where the service 230 and core 228 are separate processes, one scenario occurs when the service 230 crashes (e.g., the service process ends or freezes) and the core 228 continues running. This scenario can indicate a severe malfunction that requires restarting of the service 230.

Another scenario occurs when a block 232 within the service 230 enters an error state. Some block error states may not cause the service 230 to malfunction, but others can, such as when the block error state prevents the block 232 from accomplishing its purpose and the service 230 cannot perform its designated task due to the block's failure. This scenario may require the service 230 to be restarted depending on the severity of the block error. When a block 232 is in an error state, the service 230 may be responsive or non-responsive, depending on the particular error and how it affects the service 230. While some embodiments may allow the service 230 to restart the block 232 without having to restart the service 230, a service restart may be needed in other embodiments.

Still another scenario involves hardware issues that can affect the service 230. For example, the device on which the NIO platform instance 402 is running may not have sufficient memory for the service 230. This lack of available memory can create delays in the service's operation due to the time needed to swap data and/or instructions to and from disk, and may cause errors in the operation of the service 230. In another example, the processes running on the device may be CPU bound, with insufficient CPU cycles available to run the service 230 as expected. Such memory and CPU issues, as well as other hardware issues, may result in the service 230 appearing to be non-responsive even if the service 230 is not malfunctioning. For these and other reasons, many different issues may occur with respect to a service 230 and impact the service's ability to perform its tasks, and it is desirable for the NIO platform instance 402 to be configured to monitor and address such issues without having to restart the entire instance.

Accordingly, in step 702, the NIO platform instance 402 monitors the service 230 as the service 230 is running. The monitoring may be performed by one or more parts of the NIO platform instance 402, such as the service manager 208, the monitoring component 602, and/or another service 230. In some embodiments, the service 230 may monitor itself and report errors to other parts of the NIO platform instance 402, although this is only possible if the service 230 is in an error state that allows the service 230 to continue running and send such error reports.

In step 704, a determination is made as to whether the service 230 is running correctly. This determination may be based on one or more indicators, such as a heartbeat message, a flag, an error message, an interrupt, and/or a process list provided by the operating system. If the determination indicates that the service 230 is running correctly, the method 700 returns to step 702 and continues monitoring the service 230. It is understood that steps 702 and 704 may be viewed as a single step, with the monitoring occurring until an issue is identified with the service 230.

If the determination of step 704 indicates that the service 230 is not running correctly, the method 700 continues to step 706, where one or more defined actions are performed. The action or actions to be performed may be tied to the particular type of malfunction, to the particular service, or may be general actions that are taken regardless of the type of malfunction or service. For example, the NIO platform instance 402 may be configured to restart the service 230 only if certain error types are detected, if the service is labeled as a service that is to be restarted, or if any errors are detected regardless of the error type. The actions may be strictly internal to the NIO platform 402 (e.g., restart the service) and/or may include actions that have an external effect (e.g., send a notification message to another NIO instance or another device that the service 230 is in an error state).

Depending on the particular implementation of monitoring on the NIO platform instance 402, the monitoring functionality may be mandatory (e.g., always on) or may be turned off and on using a configurable parameter or another switch. This enables the NIO platform instance 402 to be configured as desired to monitor all, some, or none of the services 230 that are running on the NIO platform instance 402. Furthermore, different levels of monitoring and different actions may be available for different services 230. This allows the NIO platform instance 402 to be configured to monitor each service 230 in a particular way and to respond to detected issues for that service 230 as desired. It is understood that there may be a default level of monitoring applied to any service 230 running on the NIO platform instance 402 if more specific configuration parameters for a particular service 230 are not needed or available.

Referring to FIG. 8, a sequence diagram 800 illustrates one embodiment of a process that may be used to monitor a service 230. For example, the process may be used during step 702 of FIG. 7 by monitoring functionality 802, which may be one or more parts of the NIO platform instance 402, such as the service manager 208, the monitoring component 602, and/or another service 230. In this embodiment, the service 230 is configured to produce a heartbeat. For example, the service 230 may include a heartbeat block 232 or the service class itself may include heartbeat functionality, such as that provided by the heartbeat handler 610 of FIG. 6.

In step 804, the monitoring functionality 802 receives a heartbeat message from the service 230. The actual delivery of the heartbeat message depends on how service monitoring is implemented within the NIO platform 402. For example, the heartbeat message may be published via a publication/subscription channel and the monitoring functionality 802 may be a subscriber to that channel. In another example, the heartbeat message may be sent by the service 230 (e.g., from the heartbeat handler 610 of FIG. 6) directly to the monitoring functionality 802 using a channel such as the IPC channel(s) 604 of FIG. 6.

In steps 806 and 808, respectively, the monitoring functionality 802 resets a timer after receiving the heartbeat message and the timer runs. Each time a heartbeat message is received prior to step 810, steps 806 and 808 are repeated. However, in step 810, the timer expires and no heartbeat message has been received since the message in step 804. Accordingly, in step 812, the monitoring functionality 802 takes one or more defined actions due to not receiving a heartbeat message from the service 230 prior to the timer's expiration.

Referring to FIG. 9, a sequence diagram 900 illustrates one embodiment of a process that may be used to monitor a service 230. For example, the process may be used during step 702 of FIG. 7 by the monitoring functionality 802. In this embodiment, the service 230 is configured to respond to a heartbeat. For example, the service 230 may include a heartbeat response block 232 or the service class itself may include heartbeat response functionality (e.g., the heartbeat handler 610 of FIG. 6).

In steps 902 and 904, respectively, the monitoring functionality 802 sends a heartbeat message to the service 230 and maintains a timer that may be reset each time a heartbeat message is sent. As described with respect to FIG. 8, the actual delivery of the heartbeat message depends on how it is implemented within the NIO platform 402. In step 906, a response is received from the service 230. In step 908, the timer is reset because the response was received. In steps 910 and 912, another heartbeat message is sent to the service 230 and the timer runs. In step 914, the timer expires without a response being received from the service 230. In step 916, the monitoring functionality 802 takes one or more defined actions due to not receiving a heartbeat response from the service 230 prior to the timer's expiration.

Referring to FIG. 10A, a sequence diagram 1000 illustrates one embodiment of a process that may be used to monitor a service 230. For example, the process may be used during step 702 of FIG. 7 by the monitoring functionality 802. In this embodiment, the service 230 is configured to write an indicator (e.g., a health or error indicator) to memory (e.g., a known memory location or a file).

In step 1002, the service 230 sets an indicator in memory. Examples of the indicator include a flag, a timestamp, a health indicator, and/or an error indicator. For example, rather than sending a heartbeat message, the indicator's memory location may be updated with a timestamp each heartbeat cycle to show that the service 230 is functioning correctly. If the indicator is not updated, the monitoring functionality 802 would determine that something was wrong.

It is understood that the indicator may be very simple (e.g., a single bit representing a flag) or may include various types of information that provide details as to the state of the service 230. For example, the indicator may simply indicate that an error has occurred or may include information about the problem, such as identifying a type of problem (e.g., a communication problem) or identifying a particular block 232 that is in an error state. In step 1004, the monitoring functionality 802 checks the indicator in memory. In step 1006, the monitoring functionality 802 takes one or more defined actions if needed (e.g., if a problem exists as determined based on the indicator).

Referring to FIG. 10B, a sequence diagram 1010 illustrates one embodiment of a process that may be used to report the status of a service 230. In this embodiment, the service 230 monitors itself in step 1012 and sends a notification to the monitoring functionality 802 in step 1014. While similar in some aspects to the heartbeat of step 804 of FIG. 8 and the indicator of step 1002 of FIG. 10A, the present example involves an actual error detected by the service 230 and reported only when the error is detected. In step 1016, the monitoring functionality 802 can then take any needed actions in response to the notification. As the notification of step 1014 cannot be sent if the service 230 is non-functional, the sequence diagram 1010 is not applicable to all possible service malfunctions (e.g., if the service process has crashed or frozen).

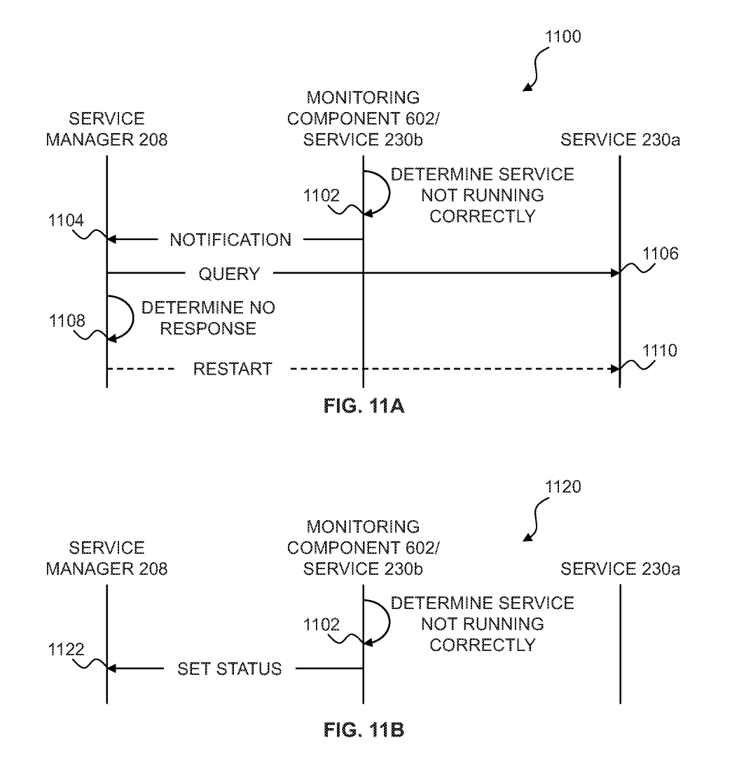

Referring to FIG. 11A, a sequence diagram 1100 illustrates one embodiment of a process that may be used to monitor a service 230a. In the present embodiment, the monitoring is performed by the monitoring component 602 or a service 230b that is configured to monitor the service 230a. For purposes of convenience, only the monitoring component 602 will be referred to in the present example, but it is understood that the service 230b may be substituted for the monitoring component 602 or used in conjunction with the monitoring component 602. If a problem is detected, the service manager 208 is notified.

Accordingly, in step 1102, the monitoring component 602 determines that the service 230a is not running correctly. For example, the monitoring component 602 may use one of the processes of FIGS. 8-10B to determine that there is a problem with the service 230a. In step 1104, the monitoring component 602 sends a notification to the service manager 208 to inform the service manager 208 that the service 230 is not functioning correctly. The notification may be sent in various ways, such as being published via a channel to which the service manager 208 is subscribed or being sent via an IPC channel that exists between the core 228/service manager 208 and the monitoring component 602.

In the present example, in step 1106, the service manager 208 sends a query to the service 230a to determine whether there is a problem. If a response to the query is received from the service 230a, the service manager 208 may assume that the service 230a is fine and ignore the notification of step 1104. In other embodiments, the service manager 208 may determine whether the service 230 is running correctly based on the contents of the response. In still other embodiments, step 1106 may be omitted and the service manager 208 may move directly to step 1110 to take action after receiving the notification of step 1104.

In step 1108, the service manager 208 determines that there has been no response to the query from the service 230a. The service manager 208 will generally wait for a defined period of time after sending the query of step 1106 before making the determination of step 1108. In some embodiments, the service manager 208 may check the current CPU utilization to determine if the service process could be CPU bound. In such cases, the service process may be unable to respond within the defined period of time because it is not being allocated sufficient CPU cycles to process the query and respond. Accordingly, if the current CPU utilization is high enough that there is a possibility that the service process is CPU bound, the service manager 208 may extend the amount of time within which a response is expected to give the service process additional time to respond. In other embodiments, such checks may not be performed.

In step 1110, the service manager 208 restarts the service 230a. In some embodiments, this may involve simply relaunching the service process without taking any other actions. In other embodiments, step 1110 may include a series of actions. For example, the service manager 208 may determine whether the service process is still running by, for example, examining a service process list maintained by the operating system of the device on which the NIO platform 402 is running. If the service process is running, the service manager 208 may close the service process (e.g., by using the operating system) before restarting the service 230a. The dotted line of step 1110 denotes that the service 230a is being relaunched by the service manager 208 and does not imply that the service manager 208 is sending a restart message to the service 230a, although step 1110 may include sending a message to the service 230a instructing the service 230a to shut down in order to be restarted.

In other embodiments, the notification of step 1102 may be an instruction to the service manager 402 to restart the service 230a. In such embodiments, steps 1104, 1106, and 1108 may be omitted, and the monitoring component 602 or service 230b makes the decision to restart the service 230a. The service manager 208 simply responds to the instruction and performs step 1110.

Referring to FIG. 11B, in step 1102, the monitoring component 602 determines that the service 230a is not running correctly as described with respect to FIG. 11A. In step 1122, the monitoring component 602 sets the status of the service 230a in the service manager 208. This may trigger additional actions (not shown). For example, the status change may trigger a notification, a restart, and/or other actions.

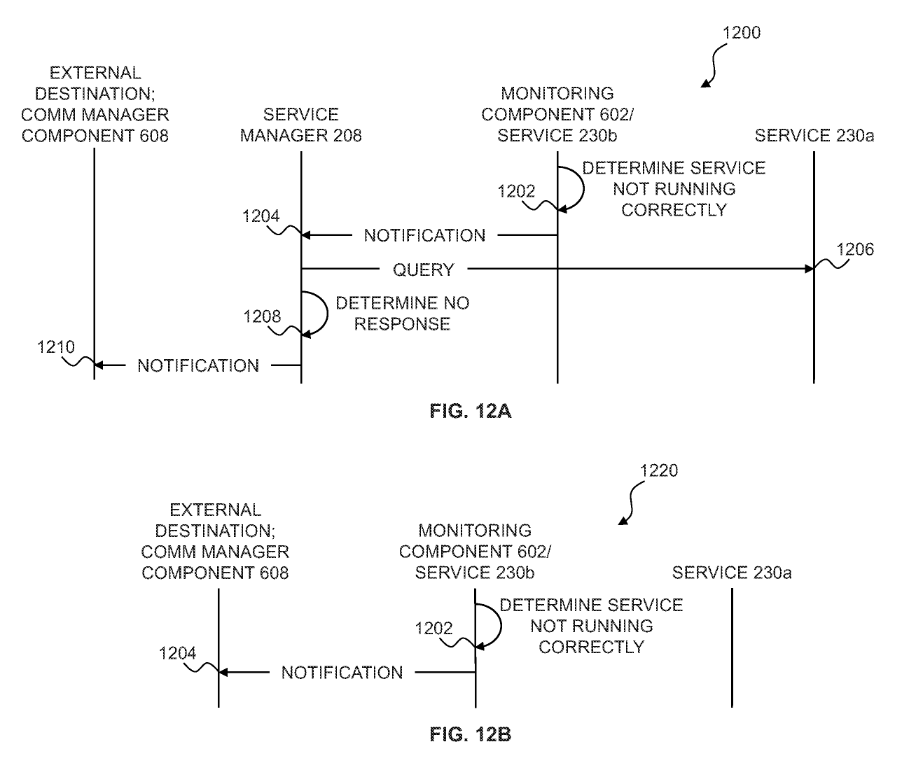

Referring to FIG. 12A, a sequence diagram 1200 illustrates one embodiment of a process that may be used to monitor a service 230a. The sequence diagram 1200 is identical to the sequence diagram 1100 of FIG. 11A except for the final step. In the present embodiment, rather than restarting the service 230a as occurs in step 1110 of FIG. 11A, the service manager 208 sends a notification in step 1210. The notification may be sent out of the NIO platform 402 (e.g., to an external destination) or within the NIO platform 402 (e.g., to a channel via the communications manager component 608). It is understood that these are examples only, and the notification may be sent to any of one or more destinations, whether internal or external of the NIO platform 402. It is further understood that both steps 1110 and 1210 may be performed, rather than serving as alternatives. In still other embodiments, steps 1206 and 1208 may be omitted.

Referring to FIG. 12B, a sequence diagram 1220 illustrates one embodiment of a process that may be used to monitor a service 230a. The sequence diagram 1220 is similar to the sequence diagram 1200 of FIG. 12A except that the monitoring component 602/service 230b may directly send the notification out of the NIO platform 402 (e.g., to an external destination) or within the NIO platform 402 (e.g., to a channel via the communications manager component 608) in step 1204. It is understood that the notification may also be sent to the service manager 208 in some embodiments as shown in FIG. 12A.

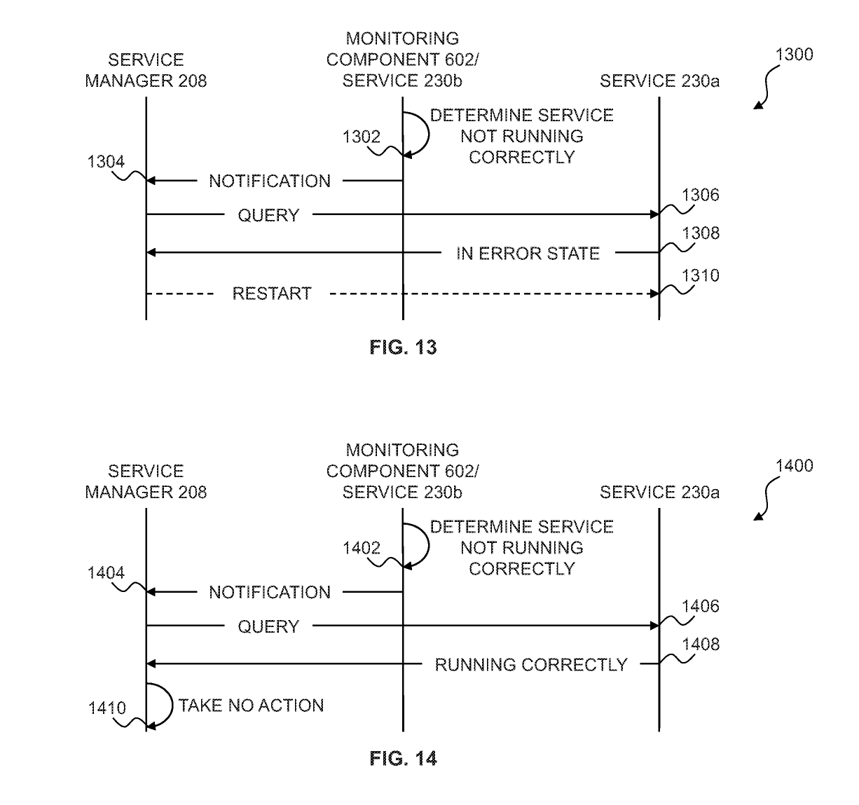

Referring to FIG. 13, a sequence diagram 1300 illustrates one embodiment of a process that may be used to monitor a service 230a. The sequence diagram 1300 is identical to the sequence diagram 1100 of FIG. 11A except for step 1308. In the present embodiment, the service manager 208 receives a response to the query of step 1306. However, as the response indicates that an error has occurred, the service manager 208 continues to step 1310 and restarts the service 230a as previously described.

Referring to FIG. 14, a sequence diagram 1400 illustrates one embodiment of a process that may be used to monitor a service 230a. The sequence diagram 1400 is identical to the sequence diagram 1300 of FIG. 13 except for steps 1408 and 1410 following the query of step 1406. In the present embodiment, the service manager 208 receives a response to the query of step 1406 and the response indicates that the service 230a is running correctly. Accordingly, the service manager 208 continues to step 1410 and takes no action regarding the service 230a because the service 230a is running correctly.

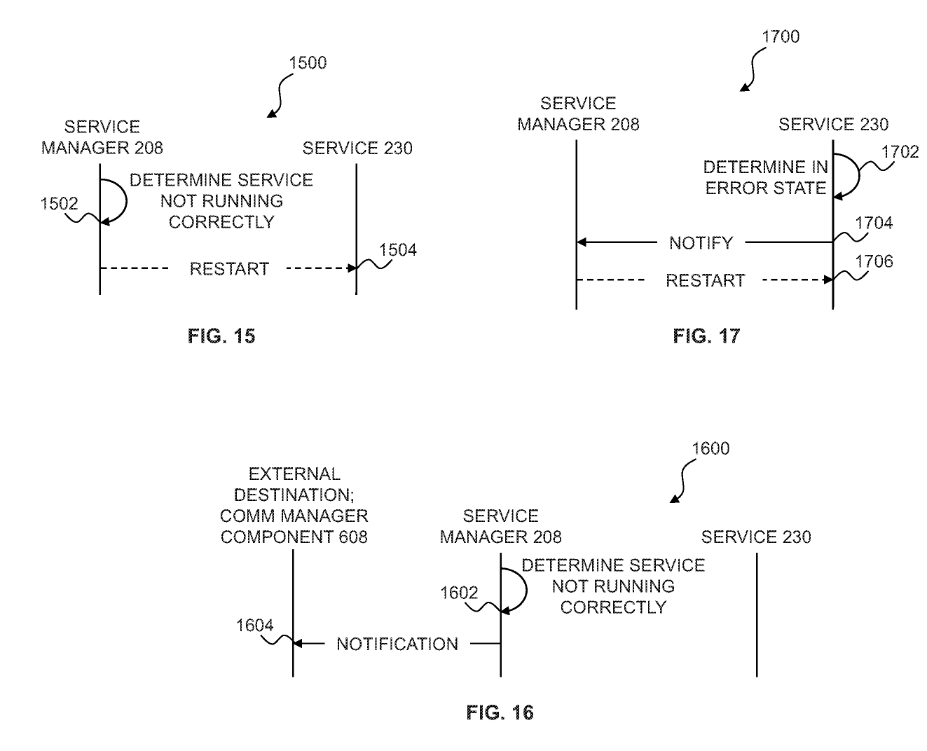

Referring to FIG. 15, a sequence diagram 1500 illustrates one embodiment of a process that may be used to monitor a service 230. In the sequence diagram 1500, the service manager 208 is responsible for both monitoring the service 230 and taking action if the service 230 not running correctly. This combines the functionality of the monitoring component 602 or service 230b of FIG. 11A with the service manager 208, and removes the separate monitoring component 602 or service 230b of FIG. 11A from the process. As each step of the sequence diagram 1500 may be performed as described in previous embodiments, some details are omitted from the present example. In step 1502, the service manager 208 determines that the service 230 is not operating correctly. Although not shown, part of step 1502 may include sending a query to the service 230 and determining that there is no response to the query. In step 1504, the service manager 208 restarts the service.

Referring to FIG. 16, a sequence diagram 1600 illustrates one embodiment of a process that may be used to monitor a service 230. The sequence diagram 1600 is identical to the sequence diagram 1500 of FIG. 15 except for the final step. In the present embodiment, rather than restarting the service 230 as occurs in step 1504 of FIG. 15, the service manager 208 sends a notification in step 1604. The notification may be sent out of the NIO platform 402 (e.g., to an external destination) or within the NIO platform 402 (e.g., to a channel via the communications manager component 608). It is understood that these are examples only, and the notification may be sent to any of one or more destinations, whether internal or external of the NIO platform 402. It is further understood that both steps 1504 and 1604 may be performed, rather than serving as alternatives.

Referring to FIG. 17, a sequence diagram 1700 illustrates one embodiment of a process that may be used to monitor a service 230. In the sequence diagram 1700, the service 230 monitors itself and the service manager 208 takes action if the service 230 not running correctly. As each step may be performed as described in previous embodiments, some details are omitted from the present example. In step 1702, the service 230 determines that it is in an error state. In step 1704, the service 230 sends a notification to the service manager 208. In step 1706, the service manager 208 restarts the service. In some embodiments, in addition to or as an alternative to restarting the service 230, the service manager 208 may send a notification described with respect to step 1604 of FIG. 16.

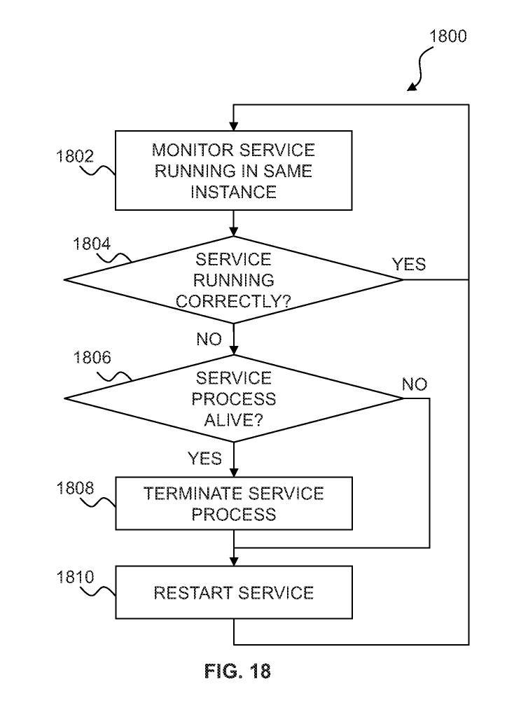

Referring to FIG. 18, a method 1800 illustrates one embodiment of a process that may be executed by the NIO platform 402 to monitor and restart a service 230. The method 1800 may be executed by one or more parts of the NIO platform instance 402, such as the service manager 208, the monitoring component 602, and/or another service 230. In some embodiments, the service 230 may monitor itself and report errors to other parts of the NIO platform instance 402.

In step 1802, the service 230 is monitored. If the service 230 is running correctly as determined in step 1804, the method 1800 returns to step 1802 and the monitoring continues. If the service 230 is not running corrected as determined in step 1804, the method 1800 moves to step 1806 and a determination is made as to whether the service process for the service 230 is alive. For example, a query may be sent to the service 230 and/or a process list provided by the operating system may be checked. If the service process is still running, the service process is terminated in step 1808. The method 1800 then restarts the service in step 1810. If the service process is not running as determined in step 1806, the method 1800 moves directly to step 1810 and restarts the service 230.

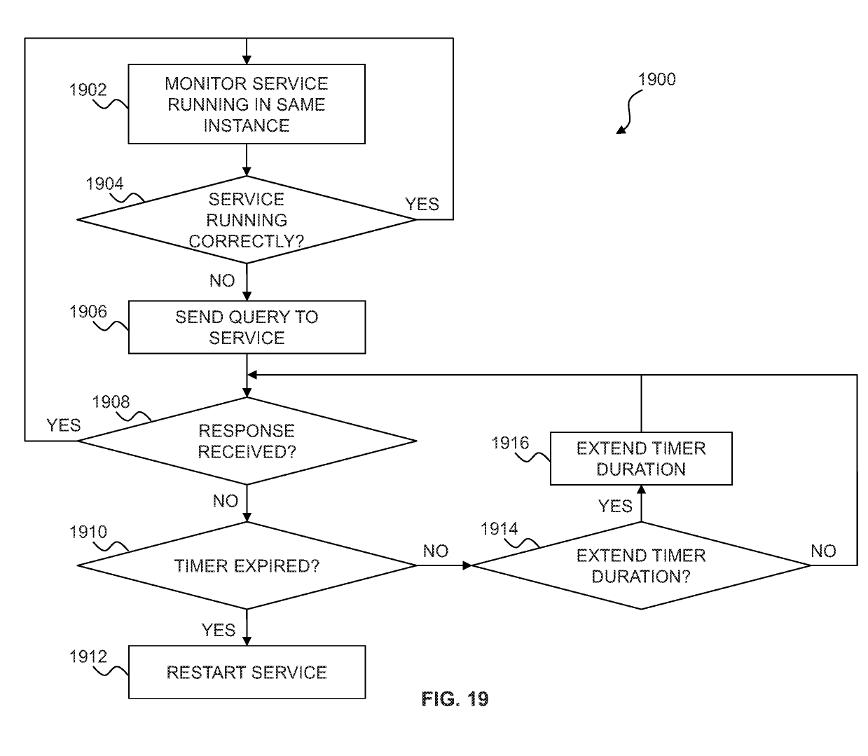

Referring to FIG. 19, a method 1900 illustrates one embodiment of a process that may be executed by the NIO platform 402 to monitor and restart a service 230. The method 1900 may be executed by one or more parts of the NIO platform instance 402, such as the service manager 208, the monitoring component 602, and/or another service 230. In some embodiments, the service 230 may monitor itself and report errors to other parts of the NIO platform instance 402.

In step 1902, the service 230 is monitored. If the service 230 is running correctly as determined in step 1904, the method 1900 returns to step 1902 and the monitoring continues. If the service 230 is not running corrected as determined in step 1904, the method 1900 moves to step 1906 and sends a query to the service 230. If a response to the query is received as determined in step 1908, the method 1900 returns to step 1902 and the monitoring continues.

If no response to the query has been received as determined in step 1908, the method 1900 moves to step 1910. In step 1910, a determination is made as to whether a timer has expired (e.g., a timer that was started when the query was sent). If the timer has expired, the method 1900 moves to step 1912 and restarts the service 230. In some embodiments, steps 1806 and 1808 of FIG. 18 may be executed between steps 1910 and 1912. If the timer has not expired as determined in step 1910, the method 1900 moves to step 1914. In step 1914, a determination is made as to whether the timer's duration should be extended (e.g., due to high CPU levels of activity). If the duration should be extended, the method 1900 moves to step 1916 and extends the duration before returning to step 1908. If the duration is not to be extended, the method 1900 moves directly to step 1908.

Although not shown, the method 1900 or other embodiments described herein may also include sending a notification message after restarting the service. For example, the service may be restarted and a message may be sent with information identifying the service, the time the service was restarted, error information as to why the service had to be restarted, and/or similar information. Such information may also be recorded in a log file.

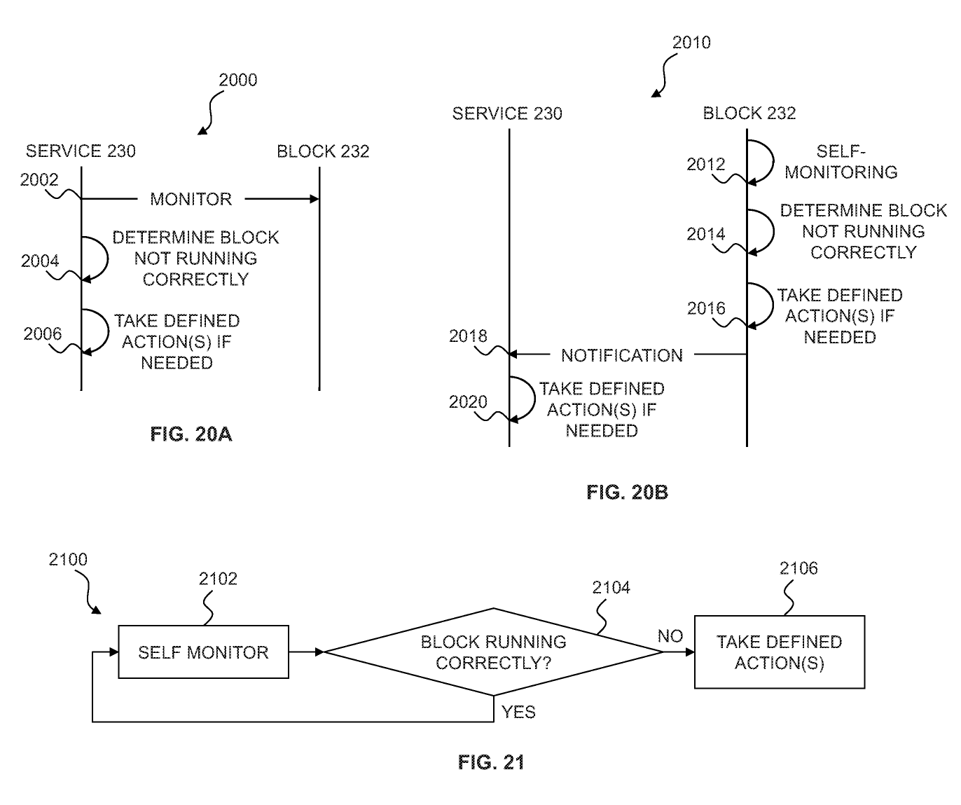

Referring to FIG. 20A, a sequence diagram 2000 illustrates one embodiment of a process that may be used to handle an error in a block 232 running within a service 230. As described previously, in addition to detecting when a service enters a different state (e.g., a warning state or error state), the NIO platform 402 may be configured to detect when individual blocks 232 within a service 230 encounter an error and enter a different state.

Because blocks 232 are asynchronous and independent components operating within the mini runtime environment provided by a service 230, the fact that the service 230 is running does not necessarily mean that each block 232 within the service 230 is functioning correctly. For example, assume a service 230 runs a block 232 that is configured to connect to an outside data source. If the block 232 is in an error state, no data may be received from the data source even though the service 230 may be running correctly. If this block error is not detected and corrected, the service 230 will not provide the expected functionality.

Depending on the particular implementation and configuration of a service 230 and/or its blocks 232, such state changes may be self-reported by a block 232 or may be detected by the service 230 that is running the block 232. For example, continuing the previous illustration of a block 232 that cannot connect to an outside data source, the block 232 may publish a notification (e.g., by notifying a management signal that is caught by the service) that it is in an error state.

In some embodiments, the response to a block's change of state may depend on which block has changed state. For example, assume that there is a service 230 designed to monitor the weight of a load being lifted by a crane to ensure that the load does not exceed a maximum threshold. This is important in order to prevent damage to the crane, to prevent damage to whatever the crane is lifting, and/or for the safety of anyone in the vicinity of the crane. The service 230 includes a block 232a that reads a load cell that measures the crane's current load, a block 232b that compares the current load to the maximum threshold, a block 232c that stops the crane if the current load exceeds the crane's maximum capacity, a block 232d that actuates an audible and/or visual alarm if the current load exceeds the crane's maximum capacity, and a block 232e that sends a notification text to the plant foreman if the current load exceeds the crane's maximum capacity.

In this example, the blocks 232a, 232b, and 232c are considered crucial since they read the weight being lifted, determine whether the weight is too heavy, and automatically stop the crane if needed. The block 232d acts as an additional safety that not only provides an indication of why the crane stopped, but also serves as a warning in case the crane fails to stop when it should. The blocks 232d and 232e provide additional features, but are not considered crucial in this example. Failure of the blocks 232a-232c is therefore considered a more serious matter than failure of the blocks 232d and 232e.

This difference may be handled in various ways. For example, failure of any of the blocks 232a-232c may put the service 230 in an error state, while failure of one of the blocks 232d and 232e may put the service 230 in a warning state (which is less serious than an error state in this example). Because the service 230 or monitoring functionality 802 may handle various states in different ways (e.g., an immediate restart for an error versus a delayed restart for a warning), the status type (e.g., the importance) of a particular block can be used to determine how to respond to an error. Errors may be further subdivided into levels of importance, so that rather than the block's status type being the only parameter that determines how an error is handled, the type of error may be considered as well. This may be particularly useful for relatively complex blocks that perform multiple functions.

Accordingly, depending on the configuration of the NIO platform 402 and its services 230 and blocks 232, errors may be handled in different ways. By providing the ability to handle errors in a configurable manner, the NIO platform 402 can be adjusted to manage particular services, blocks, and types of error as desired, or a default may be applied to some or all services, blocks, and error types.

In the example of FIG. 20A, the service 230 monitors the block 232 in step 2002. The actual monitoring process may be standardized for multiple blocks or may depend on the functionality of a particular block 232. For example, the service 230 may monitor input versus output for a particular block 232. If the input exceeds the expected output, the service 230 may interpret this as a block error. More specifically, assume for purposes of simplicity that a block 232 has a one-to-one input to output ratio. This means that for every block input, there should be a block output. If the block is not producing output at the correct rate, the service 230 can flag this as an error or warning depending on the configured parameters.

It is understood that there are many ways for the service 230 to monitor the block 232. In one example, the input/output ratio may be determined by monitoring how many times the block 232 is called versus how many times the block notifies the service 230 of output. In another example, the service 230 may monitor the block's use of a thread pool to determine if threads are being repeatedly used by the block 232 without other threads being released back to the pool. The service 230 may also determine that a block error has occurred in other ways, such as the lack of output from a polling block or the production of corrupt data.

In step 2004, the service 230 determines that the block 232 is not running correctly. In step 2006, the service 230 may execute one or more actions to address the problem. The actions may range from simply flagging the block 232 as being in a warning state to restarting the service 230.

Referring to FIG. 20B, a sequence diagram 2010 illustrates one embodiment of a process that may be used to handle an error in a block 232 running within a service 230. In the present example, the block 232 monitors itself rather than being monitored by the service 230, although the service 230 may also monitor the block 232 as previously described. Because of the asynchronous and independent nature of blocks and the wide variety of functionality that different blocks can have, self-monitoring may be ideal for error detection. Such self-monitoring functionality may be built directly into the base block class or an extended block class, or may be provided on a block by block basis as needed (e.g., via a mixin).

In step 2012, the block 232 performs self-monitoring. In step 2014, the block 232 determines that it is not running correctly. This may be due to a generic error (e.g., an error that can occur with different blocks) or an error related to the functionality of the particular block.

In step 2016, the block 232 may take one or more defined actions, although step 2016 may be omitted in some embodiments. The action(s) taken by the block 232 may be configured as desired and may be based on a particular level of error. For purposes of illustration, a warning state may be used if the block 232 is not running correctly, but determines that the error can be corrected by the block itself. An error state may be used if the block determines that it is unable to correct the error itself. The block 232 may shift from a warning state to an error state.

One example of this is a block 232 that is configured to connect to an external source or destination and is unable to connect. The block 232 may have functionality that enables it to repeatedly attempt to establish the connection a defined number of times and/or for a defined period of time. When the block 232 determines that it is not connected or cannot initially connect, the block may set its status as the warning state to indicate that it is not functioning as configured. This notifies the service 230 that there is a problem with the block 232, but the block 232 may be able to correct the problem. After the reconnection period has expired and/or the maximum number of reconnection attempts have occurred, the block 232 may change its status to the error state to indicate that it has not been able to correct the problem. This notifies the service 230 that the problem has not been corrected and the block 232 is not attempting to correct the problem.

In step 2018, the block 232 may notify the service 230 that the block is not running correctly or that the block is again running correctly. This may be accomplished in different ways, such as sending a notification to the service 230 and/or changing a status of the block 232 that is monitored by the service 230. If the block 232 is configured to attempt to correct the problem in step 2016 and is able to successfully do so, step 2018 may be a notification that the problem has been corrected. If the block 232 is configured to attempt to correct the problem in step 2016 and is unsuccessful or if the block is not configured to attempt to correct the problem, step 2018 may be a notification of the problem. In some embodiments, if the block 232 is configured to attempt to correct the problem in step 2016 and is able to successfully do so, step 2018 may be omitted entirely.

In step 2018, the service 230 may execute one or more actions to address the problem. This may include commanding the block 232 to perform one or more specified action(s). For example, if the block 232 is configured to connect to a device, the device may be checked and discovered to be offline, unplugged, or otherwise unavailable. This issue may be resolved and the device may again be available. By commanding the block 232 to retry the connection, the service 230 may avoid the need to restart, which may be another available action that can be taken by the service.

Referring to FIG. 21, a method 2100 illustrates one embodiment of a process that may be executed by a block 232 within the NIO platform 402. The method 2100 is directed to self-monitoring by the block 232. In steps 2102 and 2104, the block 232 performs self-monitoring to identify any errors that may occur in the block's operation. If no errors are detected, the steps 2102 and 2104 repeat while the block 232 is running. If step 2104 determines that an error has occurred, one or more defined actions are taken by the block 232 in step 2106.

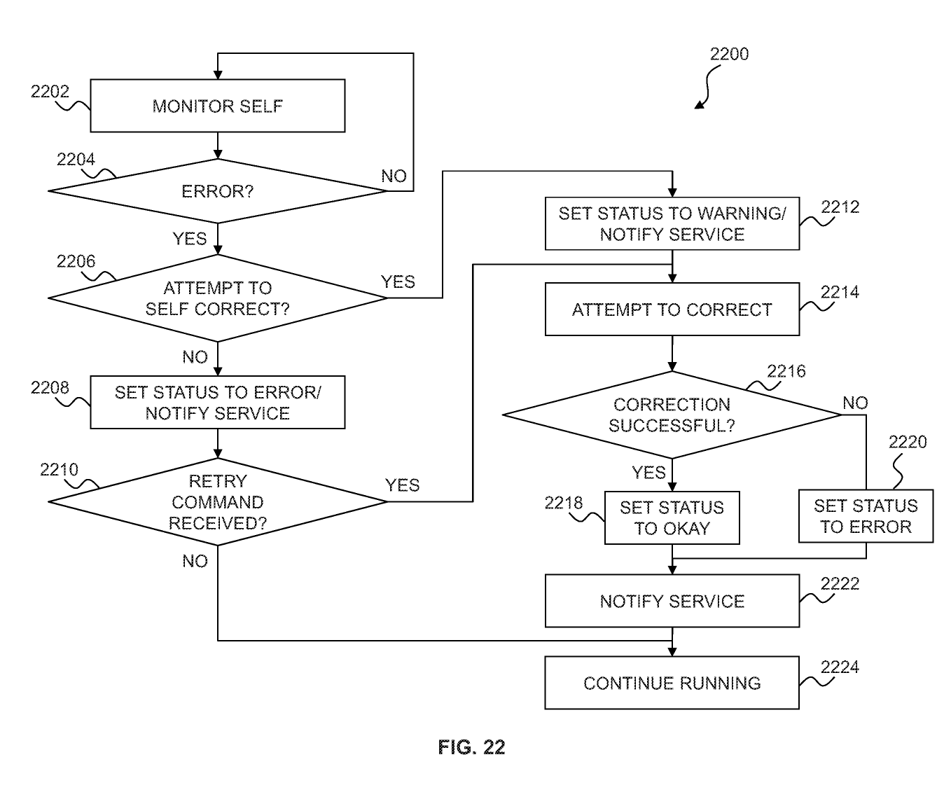

Referring to FIG. 22, a method 2200 illustrates one embodiment of a process that may be executed by a block 232 within the NIO platform 402. The method 2200 is directed to self-monitoring by the block 232.

In steps 2202 and 2204, the block 232 performs self-monitoring to identify any errors that may occur in the block's operation. If no errors are detected, the steps 2202 and 2204 repeat while the block 232 is running. If step 2204 determines that an error has occurred, the method 2200 continues to step 2206.

In step 2206, a determination is made by the block 232 as to whether to attempt to correct the error. The determination may be based on the type of error (e.g., whether the error is a correctable type) and/or other factors, such as whether the block 232 is configured to correct such errors. It is understood that in embodiments where the block 232 is not configured to attempt to self-correct errors, steps 2206 and 2208 may be omitted entirely. If the determination of step 2206 indicates that the block 232 is not to attempt to correct the error itself, the method 2200 moves to step 2208. In step 2208, the block 232 sets its status to indicate the error and/or notifies the service 230.

In step 2210, a determination is made as to whether a retry command has been received by the block 232. Although not shown, it is understood that step 2210 may be repeated any time a command is received from the service 230 during the execution of the method 2200. If the determination of step 2210 indicates that no retry command has been received, the method 2200 continues to step 2224 and the block 232 continues running in its current error state.

Returning to step 2206, if the determination of step 2206 indicates that the block 232 should attempt to correct the error, the method 2200 continues to step 2212. In step 2212, the block 232 sets its status to indicate a warning and/or notifies the service 230. Following step 2212 or if the determination of step 2210 indicates that a retry command has been received, the method 2200 continues to step 2214. In step 2214, the block 232 attempts to correct the error itself.

In step 2216, a determination is made as to whether the attempted correction was successful. If the correction was successful, the block 232 sets its status in step 2218 to indicate that it is running normally and the method 2200 continues to step 2222. If the correction was not successful, the block 232 sets its status in step 2218 to indicate the error and the method 2200 continues to step 2222. It is noted that the status may already indicate an error if set in step 2208. In such cases, the error status may be reset in step 2120 or step 2120 may be omitted. Step 2120 is mainly used to switch from the warning status of step 2212 to an error status if the block 232 cannot fix the problem itself. In step 2222, the service 230 is notified.

The method 2200 then continues to step 2224 and the block 232 continues running in its current state. Although not shown, the method 2200 may return to step 2202 for continued monitoring. The monitoring may be for additional problems if the block 232 is currently in a warning or error state, or for any problems if the block 232 is running normally.

It is understood that while monitoring a service 230 and the service's corresponding blocks 232, the status of the service and its blocks may be denoted in different ways. For example, for some blocks, the status of a malfunctioning block 232 may be set as the status of the service 230. In other embodiments, the service 230 may have its own status that is separate from the status of any of its blocks 232.

In some embodiments, a block 232 may be assigned an importance level or another indicator for use in the monitoring process. Either by itself or when combined with a particular malfunction type (e.g., an error or a warning), this indicator may affect what happens when the block 232 encounters a malfunction. For example, the status of the service 230 may be changed depending on the block's indicator type and the type of error, with more important blocks causing a change in the service's status when they encounter a malfunction and less important blocks not causing a change in the service's status when they encounter a malfunction.

When combined with the malfunction type, this may result in additional levels of granularity with respect to monitoring and/or handling malfunctions. For example, when a block 232 with an indicator representing that it is important encounters a warning level malfunction, a service status change may be triggered. However, the same block 232 with an error level malfunction may trigger a service restart. Similarly, when a block 232 with an indicator representing that it is less important encounters a warning level malfunction, only a block level status change may be triggered and not a service status change. The same block 232 with an error level malfunction may trigger a service status change. It is understood that the importance of a particular block 232 and the parameters on how different malfunctions should be handled based on block importance level and/or malfunction level may be set on a service by service basis in some embodiments.

Information defining how a particular error is to be handled for a particular service 230 and/or a particular block 232 may be defined in different places. For example, such information for a service 230 may be defined within the core 228 (e.g., within the service manager 208 and/or the monitoring component 602), the core's configuration information, the base service class 202, a particular service class, and/or the service's configuration information. Such information for a block 232 may be defined within the core 228 (e.g., within the service manager 208 and/or the monitoring component 602), the core's configuration information, the base service class 202, a particular service class, the service's configuration information, the base block class 406, the particular block class 204, and/or the block's configuration information. Default handling information may be included for use for all services 230 and blocks 232 within a NIO platform instance 402, for use with particular services and/or blocks, and/or for services and blocks for which there are no individually configured parameters.

While the preceding description shows and describes one or more embodiments, it will be understood by those skilled in the art that various changes in form and detail may be made therein without departing from the spirit and scope of the present disclosure. For example, various steps illustrated within a particular flow chart may be combined or further divided. In addition, steps described in one diagram or flow chart may be incorporated into another diagram or flow chart. Furthermore, the described functionality may be provided by hardware and/or software, and may be distributed or combined into a single platform. Additionally, functionality described in a particular example may be achieved in a manner different than that illustrated, but is still encompassed within the present disclosure. Therefore, the claims should be interpreted in a broad manner, consistent with the present disclosure.

For example, in one embodiment, a method for monitoring a service in a configurable platform instance includes monitoring, by a configurable platform instance that is configured to interact with an operating system and run any of a plurality of services defined for the configurable platform instance, a service of the plurality of services to determine whether the service is running correctly or not running correctly; determining, by the configurable platform instance, that the service is not running correctly; and performing, by the configurable platform instance, a defined action in response to determining that the service is not running correctly.

In some embodiments, performing the defined action includes restarting the service.

In some embodiments, performing the defined action includes, before restarting the service, stopping the service if the service is still running.

In some embodiments, the service is restarted using a service initialization context (SIC) corresponding to the service.

In some embodiments, the method further includes creating, by a core of the configurable platform instance, the SIC.

In some embodiments, the method further includes retrieving, by a core of the configurable platform instance, the SIC from a storage location.

In some embodiments, performing the defined action includes sending a message about the service to a destination outside of the configurable platform instance.

In some embodiments, the monitoring is performed by a core of the configurable platform instance.

In some embodiments, the determining is performed by the core.

In some embodiments, the determining includes sending, by a monitoring component within the core, a notification to a service manager within the core, wherein the notification informs the service manager that the monitor component has detected that the service is not communicating as expected.

In some embodiments, the method further includes sending, by the service manager, a message to the service, wherein the service manager determines that the service is not running correctly if no response to the message is received from the service.

In some embodiments, the monitoring is performed by a second service of the plurality of services.

In some embodiments, the method further includes notifying, by the second service, a core of the configurable platform instance that the service is not running correctly.

In some embodiments, monitoring the service includes receiving a periodic message from the service indicating that the service is running correctly.

In some embodiments, monitoring the service includes monitoring a state variable of the service having at least a first state and a second state, wherein the first state indicates that the service is running correctly and the second state indicates that the service is not running correctly.

In some embodiments, monitoring the service includes monitoring a memory location for a timestamp stored by the service, wherein the service is not running correctly if the timestamp is not refreshed within a defined time period.

In some embodiments, determining that the service is not running correctly includes identifying that a block within the service is in an error state.

In another embodiment, a system includes a processor; and a memory coupled to the processor and containing instructions for execution by the processor, the instructions for: providing a configurable platform instance that is configured to interact with an operating system and run any of a plurality of services defined for the configurable platform instance; monitoring a service of the plurality of services to determine whether the service is running correctly or not running correctly; determining that the service is not running correctly; and performing a defined action in response to determining that the service is not running correctly.

In some embodiments, performing the defined action includes restarting the service.

In some embodiments, performing the defined action includes, before restarting the service, stopping the service if the service is still running.

In some embodiments, the service is restarted using a service initialization context (SIC) corresponding to the service.

In some embodiments, the instructions further include creating, by a core of the configurable platform instance, the SIC.

In some embodiments, the instructions further include retrieving, by a core of the configurable platform instance, the SIC from a storage location.

In some embodiments, performing the defined action includes sending a message about the service to a destination outside of the configurable platform instance.

In some embodiments, the monitoring is performed by a core of the configurable platform instance.

In some embodiments, the determining is performed by the core.

In some embodiments, the determining includes sending, by a monitoring component within the core, a notification to a service manager within the core, wherein the notification informs the service manager that the monitor component has detected that the service is not communicating as expected.

In some embodiments, the instructions further include sending, by the service manager, a message to the service, wherein the service manager determines that the service is not running correctly if no response to the message is received from the service.

In some embodiments, the monitoring is performed by a second service of the plurality of services.

In some embodiments, the instructions further include notifying, by the second service, a core of the configurable platform instance that the service is not running correctly.

In some embodiments, monitoring the service includes receiving a periodic message from the service indicating that the service is running correctly.

In some embodiments, monitoring the service includes monitoring a state variable of the service having at least a first state and a second state, wherein the first state indicates that the service is running correctly and the second state indicates that the service is not running correctly.

In some embodiments, monitoring the service includes monitoring a memory location for a timestamp stored by the service, wherein the service is not running correctly if the timestamp is not refreshed within a defined time period.

In some embodiments, determining that the service is not running correctly includes identifying that a block within the service is in an error state.

In another embodiment, a software platform configured to monitor a plurality of mini runtime environments provided by the software platform includes a core having a monitoring component, wherein the core is configured to interact with an operating system running on a device on which the core is running; a plurality of services configured to be run by the core, wherein each service provides a mini runtime environment for a plurality of blocks assigned to that service; the monitoring component that monitors a current status of each service; and the plurality of blocks, wherein each of the blocks is configurable to run asynchronously and independently from the other blocks, and wherein the software platform is configurable to individually monitor any of the blocks for errors while the blocks are running within the mini runtime environment of the service to which the block is assigned.

In some embodiments, at least a first block of the plurality of blocks is configured to change a status of the first block when the first block detects an error in the first block's operation.

In some embodiments, the first block is configured to notify a first service to which the first block is assigned of the change in status.

In some embodiments, the first service is configured to notify the monitoring component of the error in the first block by changing a status of the first service to indicate the error.

In some embodiments, the first service is configured to notify the monitoring component of the error in the first block without changing a status of the first service.

In some embodiments, one of the services is configured to monitor at least a first block running within the mini runtime environment provided by the service for errors in the operation of the first block.

In some embodiments, each of the services is run as a separate process from the core.

In some embodiments, each service includes a heartbeat handler that communicates with the monitoring component to indicate the current status of the service.

In some embodiments, the core further includes a service manager that maintains a list of all services running on the software platform and the current status of each service, wherein the monitoring component updates the service manager if the current status of any of the services changes.

In some embodiments, the monitoring component is a service manager that maintains a list of all services running on the software platform and the current status of each service.

In some embodiments, at least one of the core and a first service to which a first block is assigned is configured to: identify an action that is to be taken in response to an error occurring in the first block; and initiate the action.

In another embodiment, a system includes a processor; and a memory coupled to the processor and containing instructions for execution by the processor, the instructions for: providing a software platform configured to run a plurality of services, the software platform including a core having a monitoring component, wherein the core is configured to interact with an operating system running on a device on which the core is running; the plurality of services configured to be run by the core, wherein each service provides a mini runtime environment for a plurality of blocks assigned to that service; the monitoring component that monitors a current status of each service; and the plurality of blocks, wherein each of the blocks is configurable to run asynchronously and independently from the other blocks, and wherein the software platform is configurable to individually monitor any of the blocks for errors while the blocks are running within the mini runtime environment of the service to which the block is assigned.

In some embodiments, at least a first block of the plurality of blocks is configured to change a status of the first block when the first block detects an error in the first block's operation.

In some embodiments, the first block is configured to notify a first service to which the first block is assigned of the change in status.

In some embodiments, the first service is configured to notify the monitoring component of the error in the first block by changing a status of the first service to indicate the error.

In some embodiments, the first service is configured to notify the monitoring component of the error in the first block without changing a status of the first service.

In some embodiments, one of the services is configured to monitor at least a first block running within the mini runtime environment provided by the service for errors in the operation of the first block.

In some embodiments, each of the services is run as a separate process from the core.

In some embodiments, each service includes a heartbeat handler that communicates with the monitoring component to indicate the current status of the service.

In some embodiments, the core further includes a service manager that maintains a list of all services running on the software platform and the current status of each service, wherein the monitoring component updates the service manager if the current status of any of the services changes.

In some embodiments, the monitoring component is a service manager that maintains a list of all services running on the software platform and the current status of each service.

In some embodiments, at least one of the core and a first service to which a first block is assigned is configured to: identify an action that is to be taken in response to an error occurring in the first block; and initiate the action.

In another embodiment, a method for use by a software platform includes launching, by a core of the software platform, a plurality of services, wherein each service provides a mini runtime environment for a plurality of blocks assigned to that service; monitoring, by a component of the core, a current status of each service; and individually monitoring at least some of the blocks for errors while the blocks are running within the mini runtime environment of the service to which the block is assigned, wherein each of the blocks is configurable to run asynchronously and independently from the other blocks.

In some embodiments, individually monitoring at least some of the plurality of blocks for errors includes self-monitoring by at least some of the blocks being monitored.

In some embodiments, the method further includes modifying, by a first block of the blocks being self-monitored, a status of the first block when the first block detects an error in the first block's operation.

In some embodiments, the method further includes notifying, by the first block, the service to which the first block is assigned of a change in a status of the first block.

In some embodiments, the method further includes notifying, by the service, the monitoring component of the error in the first block by changing a status of the service to indicate the error.

In some embodiments, the method further includes notifying, by the service, the monitoring component of the error in the first block without changing a status of the service.

In some embodiments, individually monitoring at least some of the plurality of blocks for errors is performed by the service to which the block being monitored is assigned.

In some embodiments, the method further includes identifying an action that is to be taken in response to an error occurring in one of the blocks being monitored; and initiating the action.

In another embodiment, a system includes a processor; and a memory coupled to the processor and containing instructions for execution by the processor, the instructions for: launching a plurality of services by a core of a software platform, wherein each service provides a mini runtime environment for a plurality of blocks assigned to that service; monitoring, by a component of the core, a current status of each service; and individually monitoring at least some of the blocks for errors while the blocks are running within the mini runtime environment of the service to which the block is assigned, wherein each of the blocks is configurable to run asynchronously and independently from the other blocks.

In some embodiments, individually monitoring at least some of the plurality of blocks for errors includes self-monitoring by at least some of the blocks being monitored.

In some embodiments, the instructions further include modifying, by a first block of the blocks being self-monitored, a status of the first block when the first block detects an error in the first block's operation.

In some embodiments, the instructions further include notifying, by the first block, the service to which the first block is assigned of a change in a status of the first block.

In some embodiments, the instructions further include notifying, by the service, the monitoring component of the error in the first block by changing a status of the service to indicate the error.

In some embodiments, the instructions further include notifying, by the service, the monitoring component of the error in the first block without changing a status of the service.

In some embodiments, individually monitoring at least some of the plurality of blocks for errors is performed by the service to which the block being monitored is assigned.

In some embodiments, at least one of the core and a first service to which a first block is assigned is configured to: identify an action that is to be taken in response to an error occurring in the first block; and initiate the action.

What is claimed is:

1. A software platform configured to monitor a plurality of mini runtime environments provided by the software platform, the software platform comprising:
a core having a monitoring component, wherein the core is configured to interact with an operating system running on a device on which the core is running;
a plurality of services configured to be run by the core, wherein each service provides a mini runtime environment for a plurality of blocks assigned to that service;
the monitoring component that monitors a current status of each service; and
the plurality of blocks, wherein each of the blocks is configurable to run asynchronously and independently from the other blocks, and wherein the software platform is configurable to individually monitor any of the blocks for errors while the blocks are running within the mini runtime environment of the service to which the block is assigned.

2. The software platform of claim 1 wherein at least a first block of the plurality of blocks is configured to change a status of the first block when the first block detects an error in the first block's operation.

3. The software platform of claim 2 wherein the first block is configured to notify a first service to which the first block is assigned of the change in status.

4. The software platform of claim 2 wherein the first service is configured to notify the monitoring component of the error in the first block by changing a status of the first service to indicate the error.

5. The software platform of claim 2 wherein the first service is configured to notify the monitoring component of the error in the first block without changing a status of the first service.

6. The software platform of claim 1 wherein one of the services is configured to monitor at least a first block running within the mini runtime environment provided by the service for errors in the operation of the first block.

7. The software platform of claim 1 wherein each of the services is run as a separate process from the core.

8. The software platform of claim 1 wherein each service includes a heartbeat handler that communicates with the monitoring component to indicate the current status of the service.

9. The software platform of claim 1 wherein the core further includes a service manager that maintains a list of all services running on the software platform and the current status of each service, wherein the monitoring component updates the service manager if the current status of any of the services changes.

10. The software platform of claim 1 wherein the monitoring component is a service manager that maintains a list of all services running on the software platform and the current status of each service.

11. The software platform of claim 1 wherein at least one of the core and a first service to which a first block is assigned is configured to:
identify an action that is to be taken in response to an error occurring in the first block; and
initiate the action.

12. A method for use by a software platform, the method comprising:
launching, by a core of the software platform, a plurality of services, wherein each service provides a mini runtime environment for a plurality of blocks assigned to that service;
monitoring, by a component of the core, a current status of each service; and
individually monitoring at least some of the blocks for errors while the blocks are running within the mini runtime environment of the service to which the block is assigned, wherein each of the blocks is configurable to run asynchronously and independently from the other blocks.

13. The method of claim 12 wherein individually monitoring at least some of the plurality of blocks for errors includes self-monitoring by at least some of the blocks being monitored.

14. The method of claim 13 further comprising modifying, by a first block of the blocks being self-monitored, a status of the first block when the first block detects an error in the first block's operation.

15. The method of claim 13 further comprising notifying, by the first block, the service to which the first block is assigned of a change in a status of the first block.

16. The method of claim 15 further comprising notifying, by the service, the monitoring component of the error in the first block by changing a status of the service to indicate the error.

17. The method of claim 15 further comprising notifying, by the service, the monitoring component of the error in the first block without changing a status of the service.

18. The method of claim 12 wherein individually monitoring at least some of the plurality of blocks for errors is performed by the service to which the block being monitored is assigned.

19. The method of claim 12 further comprising:
identifying an action that is to be taken in response to an error occurring in one of the blocks being monitored; and
initiating the action.
